(19) United States
(12) Patent Application Publication
(10) Pub. No.: US 2015/0205151 A1
(43) Pub. Date: Jul. 23, 2015

(54) LIQUID CRYSTAL DISPLAY DEVICE

(71) Applicant: Sharp Kabushiki Kaisha, Osaka-shi, Osaka (JP)

(72) Inventor: Tsuyoshi Kamada, Osaka-shi (JP)

(73) Assignee: Sharp Kabushiki Kaisha, Osaka-shi, Osaka (JP)

(21) Appl. No.: 14/423,785

(22) PCT Filed: Aug. 20, 2013
(86) PCT No.: PCT/JP2013/072141

§ 371 Date: Feb. 25, 2015

(30) Foreign Application Priority Data
Aug. 27, 2012 (JP) 2012-186663

(51) Int. Cl. G02F 1/1337; G02F 1/1335

(52) U.S. Cl. CPC G02F 1/1337; G02F 1/133504

(57) ABSTRACT

Provided is a liquid crystal display device having good display properties without complicated manufacturing processes. The liquid crystal display device includes a liquid crystal panel having: a first substrate; a second substrate; a vertical alignment film provided on each of the substrates; and a liquid crystal layer having negative dielectric anisotropy. A unit region of the liquid crystal panel includes a first domain in which an azimuth angle component of a director for liquid crystal molecules in the middle portion of the liquid crystal layer in the thickness direction is oriented in a first direction and a second domain in which the azimuth angle component for a director for liquid crystal molecules in the middle portion of the liquid crystal layer in the thickness direction is oriented in a second direction. The first direction and the second direction are non-parallel, and the twist angle of the liquid crystal molecules in the liquid crystal layer between the first substrate and the second substrate is smaller than 45°.

### TECHNICAL FIELD

The present invention relates to a liquid crystal display device.

### BACKGROUND ART

In liquid crystal display devices of a vertical alignment (VA) mode, in order to improve angle-of-view characteristics, a multi-domain vertical alignment (MVA) technique has been employed. The MVA technique divides one pixel (or sub pixel) into a plurality of regions and aligns liquid crystal molecules in a different direction for each region. Thereby, angle-of-view dependency for each region is averaged as a whole, and thus it is possible to increase the angle of view.

When a vertical electric field is applied to VA-mode liquid crystal, liquid crystal molecules are tilted from a direction of the line normal to a substrate face. At this time, a plurality of singularities of the alignment vector field of the liquid crystal molecules occur at random positions. Generally, it is unclear how many singularities occur and where singularities occur. Even in the same pixel, if the electric field is repeatedly applied and stopped, the number of occurrences and the occurrence locations of singularities are different each time. If the numbers of occurrences and the occurrence locations of singularities are dispersed, this causes roughness in display. Further, since the response speed of liquid crystal molecules in the vicinity of the singularity is slow, a residual image and the like are caused.

A method of fixing the number of occurrences and the occurrence locations of singularities is disclosed in the PTL 1 below. In the liquid crystal display device of PTL 1, a singularity control portion for generating a singularity at a predetermined position is provided in each pixel. In PTL 1, as a specific configuration of the singularity control portion, for example, there is a protrusion on an electrode or a non-electrode region formed in an electrode.

### CITATION LIST

### Patent Literature

PTL 1: Japanese Unexamined Patent Application Publication No. 2001-249340

### SUMMARY OF INVENTION

### Technical Problem

When the liquid crystal display device of PTL 1 is manufactured, a process of forming the singularity control portion such as the protrusion or the non-electrode region is necessary. Hence, manufacturing processes of the liquid crystal display device are complicated. Further, even when the technique of PTL 1 is employed, the singularities are fixed, the number of singularities is not reduced, or the singularities are not eliminated. Hence, occurrence of singularities causes problems such as deterioration in optical transmittance, roughness in display, and deterioration in responsiveness of the liquid crystal.

An embodiment of the present invention has been made to solve the above-mentioned problems, and one of objects thereof is to provide a liquid crystal display device having excellent display properties without complication of manufacturing processes.

### Solution to Problem

In order to achieve the above-mentioned object, a liquid crystal display device according to an embodiment of the present invention is characterized by including a liquid crystal panel that has first and second substrates which face each other, vertical alignment films which are respectively provided on the first and second substrates, and a liquid crystal layer which is sandwiched between the first and second substrates and has negative dielectric anisotropy, in which the liquid crystal panel has a plurality of unit regions as fundamental display units, in which each unit region has a first domain in which an azimuth angle component of a director of liquid crystal molecules in a middle portion of the liquid crystal layer in a thickness direction is oriented in a first direction, and a second domain in which an azimuth angle component of a director of liquid crystal molecules in the middle portion of the liquid crystal layer in the thickness direction is oriented in a second direction, and in which the first direction and the second direction are not parallel, and the twist angle of the liquid crystal molecules in the liquid crystal layer between the first substrate and the second substrate is smaller than 45°.

The liquid crystal display device according to the embodiment of the present invention is characterized in that an angle formed between the first direction and the second direction is equal to or greater than 6° and is equal to or less than 20°.

The liquid crystal display device according to the embodiment of the present invention is characterized in that an alignment regulation direction of the vertical alignment film on the first substrate is in parallel with an alignment regulation direction of the vertical alignment film on the second substrate, and the liquid crystal molecules in the liquid crystal layer do not twist between the first substrate and the second substrate.

The liquid crystal display device according to the embodiment of the present invention is characterized in that an alignment regulation direction of the vertical alignment film on the first substrate is not in parallel with a direction in which a boundary line between the first domain and the second domain extends, and an alignment regulation direction of the vertical alignment film on the second substrate is not in parallel with the direction in which the boundary line extends.

The liquid crystal display device according to the embodiment of the present invention is characterized in that either one of the alignment regulation direction of the vertical alignment film on the first substrate and the alignment regulation direction of the vertical alignment film on the second substrate is not in parallel with a direction in which a boundary line between the first domain and the second domain extends, and the other of the alignment regulation direction of the vertical alignment film on the first substrate and the alignment regulation direction of the vertical alignment film on the second substrate is in parallel with the direction in which the boundary line extends.

The liquid crystal display device according to the embodiment of the present invention is characterized in that an alignment regulation direction of the vertical alignment film on the first substrate is not in parallel with an alignment regulation direction of the vertical alignment film on the second substrate, and the liquid crystal molecules in the liquid crystal layer twist between the first substrate and the second substrate.

The liquid crystal display device according to the embodiment of the present invention is characterized by further including a light diffusion member that has a diffusion intensity which is different in accordance with an azimuth angle direction on a light emission side of the liquid crystal panel, in which an azimuth angle direction, in which the diffusion intensity of the light diffusion member is relatively large, substantially coincides with an azimuth angle direction in which change in transmittance of the liquid crystal panel is relatively large.

The liquid crystal display device according to the embodiment of the present invention is characterized in that the light diffusion member has a base which has optical transparency, a plurality of light blocking portions formed on a first face of the base, and a light diffusion portion formed in a region other than a region, in which the light blocking portion is formed, on the first face, the light diffusion portion has a light emission end face on a side of the base and a light incidence end face having an area larger than an area of the light emission end face on a side opposite to the side of the base, and a height from the light incidence end face of the light diffusion portion to the light emission end face is greater than a thickness of the light blocking portion, and a planar shape of the light blocking portion is an anisotropic shape having a major axis and a minor axis.

### Advantageous Effects of Invention

According to the embodiment of the present invention, it is possible to provide a liquid crystal display device having excellent display properties without complication of manufacturing processes.

### BRIEF DESCRIPTION OF DRAWINGS

FIG. 1 is a cross-sectional view illustrating a liquid crystal display device according to a first embodiment of the present invention.

FIG. 2(A) is a plan view illustrating two sub pixels adjacent to each other in the liquid crystal display device according to the first embodiment, FIG. 2(B) is a cross-sectional view taken along the line A-A′ of FIG. 2(A), and FIG. 2(C) is a cross-sectional view taken along the line B-B′ of FIG. 2(A).

FIG. 3 is a diagram illustrating definition of an alignment regulation angle of liquid crystal molecules.

FIG. 4 is a plan view illustrating two sub pixels adjacent to each other in a liquid crystal display device according to Comparative Example 1.

FIGS. 5(A) to 5(F) are diagrams illustrating simulation results of a state where singularities occur, in liquid crystal display devices according to Comparative Example 1 and Examples 1 to 5.

FIG. 6 is a diagram illustrating simulation results of the liquid crystal display device according to Comparative Example 1 of FIG. 5(A) in an enlarged manner.

FIG. 7 is a diagram illustrating simulation results of the liquid crystal display device according to Example 4 of FIG. 5(E) in an enlarged manner.

FIGS. 8(A) to 8(G) are schematic diagrams illustrating types of singularities.

FIG. 9(A) is a plan view illustrating two sub pixels adjacent to each other in a liquid crystal display device according to Comparative Example 2, FIG. 9(B) is a cross-sectional view taken along the line A-A′ of FIG. 9(A), and FIG. 9(C) is a cross-sectional view taken along the line B-B′ of FIG. 9(A).

FIG. 10 is a diagram illustrating a simulation result of a state where singularities occur, in the liquid crystal display device according to Comparative Example 2 of FIGS. 9(A) to 9(C).

FIG. 11 is a plan view illustrating two pixels adjacent to each other in a liquid crystal display device according to Comparative Example 3.

FIG. 12 is a diagram illustrating a simulation result of a state where singularities occur, in the liquid crystal display device according to Comparative Example 3 of FIG. 11.

FIG. 13 is a plan view illustrating two sub pixels adjacent to each other in a liquid crystal display device according to a second embodiment.

FIG. 14 is a diagram illustrating a simulation result of a state where singularities occur, in the liquid crystal display device according to the second embodiment of FIG. 13.

FIG. 15 is a plan view illustrating two sub pixels adjacent to each other in a liquid crystal display device according to a third embodiment.

FIG. 16 is a diagram illustrating a simulation result of a state where singularities occur, in the liquid crystal display device according to the third embodiment of FIG. 15.

FIG. 17 is a plan view illustrating two sub pixels adjacent to each other in a liquid crystal display device according to a modification example of the third embodiment.

FIG. 18 is a plan view illustrating two sub pixels adjacent to each other in a liquid crystal display device according to a fourth embodiment.

FIG. 19 is a plan view illustrating two sub pixels adjacent to each other in a liquid crystal display device according to Comparative Example 4.

FIGS. 20(A) and 20(B) are diagrams illustrating simulation results of a state where singularities occur, in liquid crystal display devices according to Comparative Example 4 of FIG. 19 and the fourth embodiment of FIG. 18.

FIG. 21 is a plan view illustrating two sub pixels adjacent to each other in a liquid crystal display device according to a fifth embodiment.

FIG. 22 is a plan view illustrating two sub pixels adjacent to each other in a liquid crystal display device according to Comparative Example 5.

FIGS. 23(A) and 23(B) are diagrams illustrating simulation results of a state where singularities occur, in liquid crystal display devices according to Comparative Example 5 of FIG. 22 and the fifth embodiment of FIG. 21.

FIG. 24 is a perspective view illustrating a schematic configuration of a liquid crystal display device according to a sixth embodiment.

FIG. 25(A) is a cross-sectional view illustrating the liquid crystal display device according to the sixth embodiment, and FIG. 25(B) is a cross-sectional view illustrating a part of a light diffusion film.

FIG. 26 is a schematic diagram illustrating a relationship between light distribution of a backlight, a pixel arrangement of a liquid crystal panel, and arrangement of a light diffusion film, in the liquid crystal display device according to the sixth embodiment.

### DESCRIPTION OF EMBODIMENTS

### First Embodiment

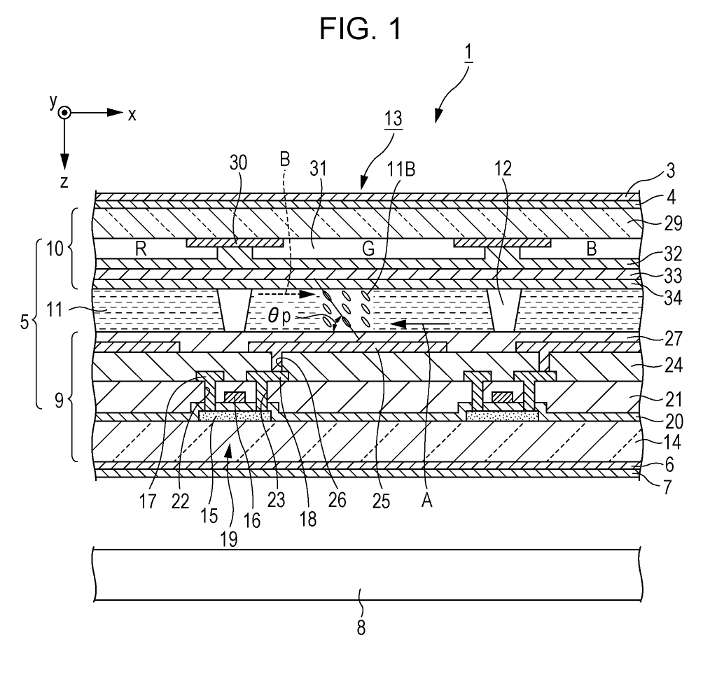

Hereinafter, a first embodiment of the present invention will be described with reference to FIGS. 1 to 12.

A liquid crystal display device according to the present embodiment is an example of a VA-mode liquid crystal display device in which two domains are provided in one sub pixel.

FIG. 1 is a cross-sectional view illustrating a liquid crystal display device according to the present embodiment.

It should be noted that, in the following drawings, in order to allow components to be seen easily, the components may be shown with dimensions at different scales.

The liquid crystal display device 1 according to the present embodiment includes, as shown in FIG. 1, a liquid crystal panel 13 and a backlight 8. The liquid crystal panel 13 includes a first polarization plate 3, a first phase difference plate 4, a liquid crystal cell 5, a second phase difference plate 6, and a second polarization plate 7. The backlight 8 is disposed below the liquid crystal panel 13 of FIG. 1. In the liquid crystal display device 1 according to the present embodiment, light emitted from the backlight 8 is modulated for each pixel by the liquid crystal panel 13, and predetermined images, characters, and the like are displayed using the light modulated for each pixel.

An observer views the display from the upper side above the liquid crystal display device 1 of FIG. 1. In the following description, the upper side of the liquid crystal display device 1 is referred to as a viewing side or a front side, and the lower side (a side on which the backlight 8 is disposed) of the liquid crystal display device 1 is referred to as a rear side. In the following description, the x axis is defined as a horizontal direction of a screen of the liquid crystal display device 1, the y axis is defined as a vertical direction of the screen of the liquid crystal display device 1, and the z axis is defined as a thickness direction of the liquid crystal display device 1.

Hereinafter, a specific configuration of the liquid crystal panel 13 will be described.

Here, an active-matrix transmissive liquid crystal panel will be described as an example, but a liquid crystal panel, which can be applied to the present invention, is not limited to the active-matrix transmissive liquid crystal panel. The liquid crystal panel, which can be applied to the present invention, may be, for example, a semi-transmissive (transmissive-reflective-combined) liquid crystal panel, and may be a simple matrix liquid crystal panel in which each pixel has no switching thin film transistor (hereinafter abbreviated as a TFT).

The liquid crystal cell 5 constituting the liquid crystal panel 13 has a TFT substrate 9 as a switching element substrate, a color filter substrate 10 which is disposed to face the TFT substrate 9, and a liquid crystal layer 11 which is sandwiched between the TFT substrate 9 and the color filter substrate 10. The liquid crystal layer 11 is enclosed in a space surrounded by the TFT substrate 9, the color filter substrate 10, and a seal material (not shown in the drawing). The seal material has a frame shape, and the TFT substrate 9 and the color filter substrate 10 are bonded by the seal material with predetermined spacing interposed there between. The liquid crystal cell 5 of the present embodiment performs display in the VA mode, and thus the liquid crystal layer 11 employs liquid crystal of which the permittivity anisotropy is negative. Between the TFT substrate 9 and the color filter substrate 10, spacers 12 each of which has a columnar shape for maintaining a constant distance between the substrates are disposed. The spacers 12 are made of, for example, resin, and are formed by a photolithography technique.

The second polarization plate 7, which functions as a polarizer, is provided on a side of the liquid crystal cell 5 close to the backlight 8. The first polarization plate 3, which functions as a photodetector, is provided on the viewing side of the liquid crystal cell 5. The second phase difference plate 6, which is for compensating for the light phase difference, is provided between the second polarization plate 7 and the liquid crystal cell 5. Likewise, the first phase difference plate 4, which is for compensating for the light phase difference, is provided between the first polarization plate 3 and the liquid crystal cell 5.

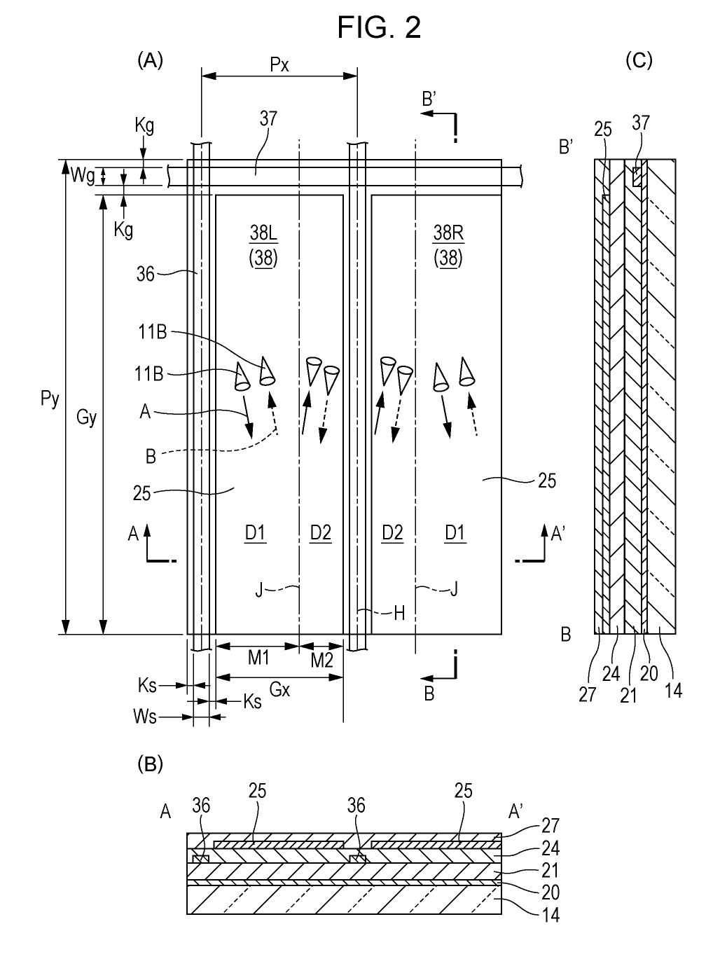

A plurality of sub pixels, each of which is a minimum unit region of display, are arranged in a matrix shape on the TFT substrate 9. A plurality of source bus lines 36 (refer to FIG. 2(A)) are formed on the TFT substrate 9 so as to extend in parallel with one another. A plurality of gate bus lines 37 (refer to FIG. 2(A)) are formed on the TFT substrate 9 so as to extend in parallel with one another and be orthogonal to the plurality of source bus lines 36. Accordingly, the plurality of source bus lines 36 and the plurality of gate bus lines 37 are formed on the TFT substrate 9 in a lattice shape. A region, which has a rectangular shape partitioned by the source bus line 36 and the gate bus line 37, is one sub pixel 38. The source bus line 36 is connected to a source electrode of the TFT to be described later, and the gate bus line 37 is connected to a gate electrode of the TFT.

TFTs 19, each of which has a semiconductor layer 15, a gate electrode 16, a source electrode 17, a drain electrode 18, and the like, are formed on a surface of a transparent substrate 14, which constitutes the TFT substrate 9, close to the liquid crystal layer 11. As the transparent substrate 14, for example, a glass substrate can be used. A semiconductor layer 15 is formed of a semiconductor material on the transparent substrate 14. Examples of the semiconductor material include continuous grain silicon (CGS), low-temperature poly-silicon (LPS), amorphous silicon (α-Si), and the like. A gate insulation film 20 is formed on the transparent substrate 14 so as to cover the semiconductor layer 15. As a material of the gate insulation film 20, for example, a silicon oxide film, a silicon nitride film, a film on which these films are laminated, or the like is used. The gate electrodes 16 are formed on the gate insulation film 20 so as to face the semiconductor layer 15. As a material of the gate electrodes 16, for example, a laminated film of tungsten (W)/tantalum nitride (TaN), molybdenum (Mo), titanium (Ti), aluminum (Al), or the like is used.

A first interlayer insulation film 21 is formed on the gate insulation film 20 so as to cover the gate electrodes 16. As a material of the first interlayer insulation film 21, for example, a silicon oxide film, a silicon nitride film, a film on which these films are laminated, or the like is used. The source electrodes 17 and the drain electrodes 18 are formed on the first interlayer insulation film 21. Each source electrode 17 is connected to a source region of the semiconductor layer 15 through a contact hole 22 which passes through the first interlayer insulation film 21 and the gate insulation film 20. Likewise, each drain electrode 18 is connected to a drain region of the semiconductor layer 15 through a contact hole 23 which passes through the first interlayer insulation film 21 and the gate insulation film 20. As a material of the source electrodes 17 and the drain electrodes 18, a conductive material, which is the same as that of the above-mentioned gate electrode 16, is used. A second interlayer insulation film 24 is formed on the first interlayer insulation film 21 so as to cover the source electrodes 17 and the drain electrodes 18. As a material of the second interlayer insulation film 24, a material, which is the same as that of the above-mentioned first interlayer insulation film 21, or an organic insulating material is used.

Pixel electrodes 25 are formed on the second interlayer insulation film 24. Each pixel electrode 25 is connected to the drain electrode 18 through the contact hole 26 which passes through the second interlayer insulation film 24. Accordingly, the pixel electrode 25 is connected to the drain region of the semiconductor layer 15 through the drain electrode 18 as a relay electrode. As a material of the pixel electrode 25, for example, a transparent conductive material such as indium tin oxide (ITO) or indium zinc oxide (IZO) is used. With such a configuration, when a scanning signal is supplied to the gate electrode 16 through the gate bus line 37, the TFT 19 is turned on. At this time, an image signal, which is supplied to the source electrode 17 through the source bus line 36, is supplied to the pixel electrode 25 through the semiconductor layer 15 and the drain electrode 18.

It should be noted that, as the form of the TFTs, top gate type TFTs shown in FIG. 2 may be used, and bottom gate type TFTs may be used.

Meanwhile, a black matrix 30, color filters 31, a planarizing layer 32, a counter electrode 33, and an alignment film 34 are sequentially formed on a surface of the transparent substrate 29, which constitutes the color filter substrate 10, close to the liquid crystal layer 11. The black matrix 30 has a function of preventing light from being transmitted through regions between pixels, and is formed of a metal, such as chromium (Cr) or a multilayer film made of Cr/Cr oxide, or a photoresist in which carbon particles are distributed in photosensitive resin.

The color filters 31 includes coloring materials of respective colors of red (R), green (G), and blue (B), and the color filter 31 corresponding to any one of R, G, and B is disposed to face one pixel electrode 25 on the TFT substrate 9. A region, in which the color filter 31 corresponding to any one of R, G, and B is disposed, constitutes a sub pixel. Three sub pixels of R, G, and B constitute one pixel. The “sub pixel” of the present embodiment corresponds to the “unit region” in claims. In a case of a liquid crystal display device in which there is no color filter, there is no concept of the sub pixel, and thus the “pixel” corresponds to the “unit region” in claims.

The planarizing layer 32 is formed of an insulation film covering the black matrix 30 and the color filters 31, and has a function of smoothing and planarizing unevenness by using the black matrix 30 and the color filters 31. The counter electrode 33 is formed on the planarizing layer 32. As a material of the counter electrode 33, a transparent conductive material, which is the same as that of the pixel electrode 25, is used. The color filters 31 may be configured to have a multiple number of colors greater than the three colors of R, G, and B.

In a case of the present embodiment, three colors of the color filters 31 are R, G, and B, and are arranged in the horizontal direction (x axis direction) of a display screen of the liquid crystal panel 5, as shown in FIG. 1.

An alignment film 27 is formed on the entire surface of the second interlayer insulation film 24 so as to cover the pixel electrode 25, on the TFT substrate 9. An alignment film 34 is formed on the entire surface of the color filter substrate 10 covering the counter electrode 33. The alignment film 27 and the alignment film 34 have an alignment regulation force which vertically aligns the liquid crystal molecules 11B constituting the liquid crystal layer 11. The alignment film 27 and the alignment film 34 are so-called vertical alignment films. In the present embodiment, an alignment process is performed on the alignment film 27 and the alignment film 34 by using a photo-alignment technique.

The alignment processes are performed on the alignment film 27 on the TFT substrate 9 and on the alignment film 34 on the color filter substrate 10 in directions which are parallel with each other and opposite to each other. For example, as shown in FIG. 1, the alignment process is performed on the alignment film 27 on the TFT substrate 9 in a direction (direction from the right side toward the left side of FIG. 1) indicated by the solid arrow A. The alignment process is performed on the alignment film 34 on the color filter substrate 10 in a direction (direction from the left side toward the right side of FIG. 1) indicated by the dashed arrow B. Through such alignment processes, the end portion of the liquid crystal molecules 11B, which constitute the liquid crystal layer 11, close to the TFT substrate 9 is tilted toward the right side in a direction of the line normal to the surfaces of both alignment films 27 and 34, and the end portion thereof close to the color filter substrate 10 is tilted toward the left side. By performing the alignment processes on both alignment films 27 and 34 in directions which are parallel with each other and opposite to each other, the liquid crystal molecules 11B can be stably tilted. Due to the tilt of the liquid crystal molecules 11B when a voltage is not applied, the liquid crystal molecules 11B are significantly tilted when a voltage is applied.

In the following description, directions (directions of the solid arrow A and the dashed arrow B) of the alignment processes are referred to as alignment regulation directions. The alignment regulation directions described herein are indicated by azimuth angle directions when the TFT substrate 9 or the color filter substrate 10 is viewed from the normal line direction.

Although not shown in FIG. 1, the alignment film 27 on the TFT substrate 9 has two regions of which the alignment regulation directions are different from each other. Likewise, the alignment film 34 on the color filter substrate 10 has two regions of which the alignment regulation directions are different from each other. This point will be described later.

FIG. 2(A) is a diagram illustrating the TFT substrate 9, and is a plan view illustrating two sub pixels 38 adjacent to each other. FIG. 2(B) is a cross-sectional view taken along the line A-A′ of FIG. 2(A). FIG. 2(C) is a cross-sectional view taken along the line B-B′ of FIG. 2(A). FIGS. 2(B) and 2(C) are cross-sectional views of the TFT substrate 9, and do not show the color filter substrate 10 and the liquid crystal layer 11.

The lines, which extend in the horizontal direction in FIG. 2(A), are the gate bus lines 37. The lines, which extend in the vertical direction in FIG. 2(A), are the source bus lines 36. The gate bus lines 37 and the source bus lines 36 are orthogonal to each other. The rectangular region, which is surrounded by two gate bus lines 37 adjacent to each other and two source bus lines 36 adjacent to each other, is one sub pixel 38. The above-mentioned TFTs 19 are disposed near intersection points between the gate bus lines 37 and the source bus lines 36, but are not shown in FIG. 2(A). The rectangular pixel electrode 25 is disposed inside the sub pixel 38 surrounded by the gate bus line 37 and the source bus line 36.

Inventors of the present invention have performed simulation of an alignment state of the liquid crystal molecules 11B in order to demonstrate the effect of the liquid crystal display device 1 according to the present embodiment. Although the results will be described later, examples of the dimensions of the respective sections used in the simulation will be described herein.

Regarding the size of the sub pixel 38, a dimension Px thereof in the x axis direction (direction along the gate bus line 37) is 100 μm, and a dimension Py thereof in the y axis direction (direction along the source bus line 36) is 300 μm. In FIG. 2(A), only the two sub pixels 38 adjacent to each other are shown, and the same structures are repeatedly disposed outside the pixels. A width Wg of the gate bus line 37 is 10 μm, and a gap Kg between the gate bus line 37 and each pixel electrode 25 above and below the gate bus line is 5 μm. A width Ws of the source bus line 36 is 4 μm, and a gap Ks between the source bus line 36 and each pixel electrode 25 on the right and left sides of the source bus line is 3 μm. Regarding the size of the pixel electrode 25, a dimension Gx thereof in the x axis direction is 90 μm, and a dimension Gy thereof in the y axis direction is 280 μm.

A relative permittivity of the first interlayer insulation film 21 between the gate bus line 37 and the source bus line 36 shown in FIGS. 2(B) and 2(C) is 6, and a film thickness thereof is 400 nm. A relative permittivity of the second interlayer insulation film 24 between the source bus line 36 and the pixel electrode 25 shown in FIGS. 2(B) and 2(C) is 4, and a film thickness thereof is 2 μm.

In the following description, in the plan view of FIG. 2(A), the sub pixel 38 on the left side is referred to as a first sub pixel 38L, and the sub pixel 38 on the right side is referred to as a second sub pixel 38R.

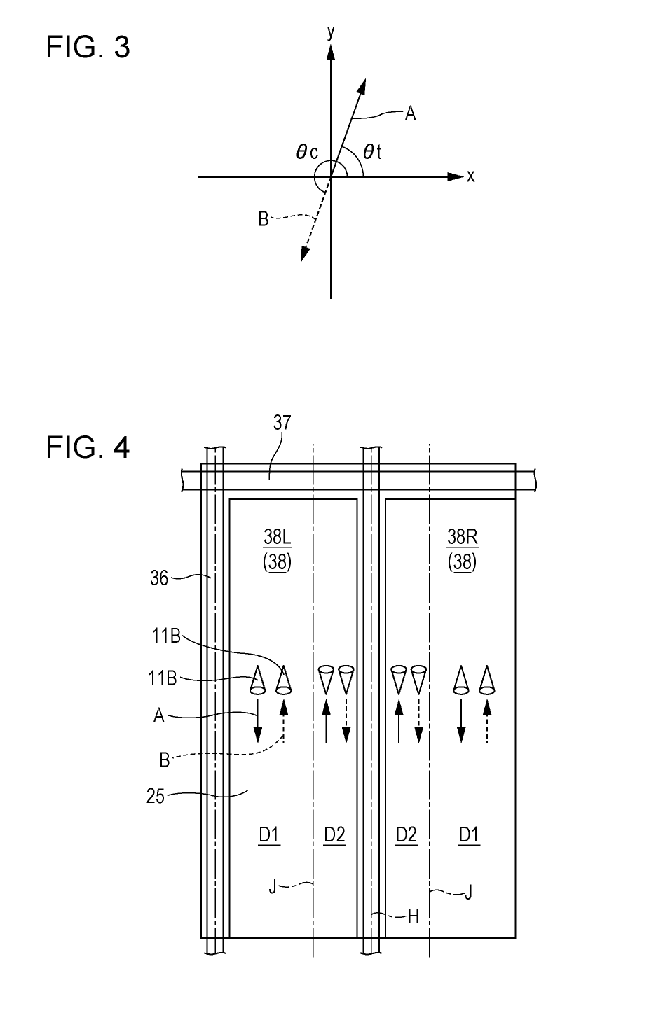

An angle, which is represented as an azimuth angle of the alignment regulation direction of the alignment film 27 or 34, is defined as an alignment regulation angle. The alignment regulation angles θt and θc are, as shown in FIG. 3, angles of the arrows A and B indicated by the alignment regulation directions of the respective alignment films 27 and 34 as viewed in terms of counterclockwise rotation on the basis of the positive direction (3 o'clock direction) of the x axis. The alignment regulation angle of the alignment film 27 on the TFT substrate 9 is denoted by θt, and the alignment regulation angle of the alignment film 34 on the color filter substrate 10 is denoted by θc. As described above, the alignment regulation direction of the alignment film 27 on the TFT substrate 9 and the alignment regulation direction of the alignment film 34 on the color filter substrate 10 are directions which are parallel with each other and opposite to each other. Hence, the alignment regulation angle θt is shifted from the alignment regulation angle θc by 180°.

As shown in FIG. 2(A), in each of the first sub pixel 38L and the second sub pixel 38R, the alignment film 27 on the TFT substrate 9 has two domains of which the alignment regulation directions are different. Likewise, the alignment film 34 on the color filter substrate 10 has two domains, of which the alignment regulation directions are different, so as to correspond to the alignment film 27 on the TFT substrate 9. Specifically, the first sub pixel 38L has a first domain D1 and a second domain D2. In the first domain D1, the alignment regulation angle θt is greater than 270° and is equal to or less than 280°, and the alignment regulation angle θc is greater than 90° and is equal to or less than 100°. In the second domain D2, the alignment regulation angle θt is equal to or greater than 80° and is less than 90°, and the alignment regulation angle θc is equal to or greater than 260° and is less than 270°.

As shown in FIG. 2(A), the above-mentioned alignment films 27 and 34 align the liquid crystal molecules 11B in the first domain D1 and the second domain D2 respectively in the following manner. The end portion of the liquid crystal molecules 11B close to the color filter substrate 10 is oriented toward the leading end of the solid arrow A which indicates the alignment regulation direction of the TFT substrate 9. The end portion of the liquid crystal molecules 11B close to the TFT substrate 9 is oriented toward the leading end of the dashed arrow B which indicates the alignment regulation direction of the color filter substrate 10. That is, each of the first sub pixel 38L and the second sub pixel 38R has the two domains D1 and D2 in which directions of the directors of the liquid crystal molecules 11B are different.

In the following drawings, the liquid crystal molecules 11B aligned in the above-mentioned directions are indicated by a conical figure shown in FIG. 2(A). The circular face of the conical shape, which indicates the liquid crystal molecules 11B, indicates the end portion of the liquid crystal molecules 11B close to the color filter substrate 10, and the tip side thereof indicates the end portion of the liquid crystal molecules 11B close to the TFT substrate 9. Here, the directions of the directors of the liquid crystal molecules 11B are typified by the direction of the director of the liquid crystal molecules 11B positioned in the middle portion of the liquid crystal layer 11 in the thickness direction.

As described above, each of the sub pixels 38L and 38R has the first domain D1 and the second domain D2. In the first domain D1, the azimuth angle component of the director of the liquid crystal molecules 11B in the middle portion of the liquid crystal layer 11 in the thickness direction is oriented in the first direction. In the second domain D2, the azimuth angle component of the director of the liquid crystal molecules 11B in the middle portion of the liquid crystal layer 11 in the thickness direction is oriented in the second direction. The first direction is not in parallel with the second direction.

Each boundary line J between the first domain D1 and the second domain D2 extends in a direction (y axis direction) which is in parallel with the source bus line 36. Each boundary line J is at a position shifted from the center of each of the sub pixels 38L and 38R, and thus the size of the first domain D1 is different from the size of the second domain D2. The pixel electrode 25 with a width of 90 μm is divided into two parts by the boundary line J. For example, a width M1 of the first domain D1 is 60 μm, and a width M2 of the second domain D2 is 30 μm. In the first sub pixel 38L, the first domain D1 is disposed on the left side, and the second domain D2 is disposed on the right side. In contrast, in the second sub pixel 38R, the first domain D1 is disposed on the right side, and the second domain D2 is disposed on the left side.

As described above, in the case of the present embodiment, the first domain D1 and the second domain D2 are arranged to be symmetric to each other with respect to a boundary line H between the first sub pixel 38L and the second sub pixel 38R. Further, due to this arrangement, when the first sub pixel 38L and the second sub pixel 38R are aligned, the width M1 of the first domain D1 and the width M2 of the second domain D2 are substantially equal. With such a configuration, a configuration of a mask, which is used in a photo-alignment process performed on each of the alignment films 27 and 34, is simplified.

The alignment direction of the liquid crystal molecules 11B with respect to the direction of the azimuth angle in the plan view of the liquid crystal panel 13 is as described above. Meanwhile, as viewed from the cross-section of the liquid crystal panel 13, as shown in FIG. 1, an angle of the director of the liquid crystal molecules 11B, to which a voltage is not applied, to the substrate surface, a so-called pre-tilt angle θp, is 88°. Further, a twist angle of the liquid crystal molecules 11B is 0°. That is, in the case of the present embodiment, the liquid crystal molecules 11B do not twist in the thickness direction of the liquid crystal layer 11.

Hereinafter, description will be given of results of simulations of the alignment states of the liquid crystal molecules performed by inventors of the present invention.

The configuration of the liquid crystal display device, on which the simulations were performed, is as described above. The dimensions of the respective sections are the same as those in the above description.

As a simulation tool, the LCD Master3D Ver.8.1.0.1 (made by Shintech Corp.) was used. As parameters other than the above-mentioned parameters, elastic moduli k1, k2, and k3 of liquid crystal constituting the liquid crystal layer 11 were set to be equal to 13.6, 8.0, and 13.0. The permittivities ep and es of the liquid crystal were set to be equal to 3.5 and 6.5. The film thickness of the gate insulation film 20 was set to 0.4 μm, the thickness of the liquid crystal layer 11 was set to 3.5 μm, and the thickness of the electrode was set to 0 μm.

Transmission axes of two polarization plates 3 and 7, between which the liquid crystal layer 11 is interposed, were arranged in a crossed-nicols manner so as to be in the 0°-180° direction and the 90°-270° direction. As the voltage applied to the liquid crystal layer 11, the gate voltage was set to −12 V, the source voltage was set to 0 V, and a common voltage was set to 0 V. For the first sub pixel 38L, the voltage applied to the pixel electrode 25 was changed from 0 V to +7 V in 1 V steps. For the second sub pixel 38R, the voltage applied to the pixel electrode 25 was changed from 0 V to −7 V in −1 V steps.

As Comparative Example 1, the liquid crystal display device shown in FIG. 4 is provided. FIG. 4 is a plan view illustrating two sub pixels adjacent to each other in the liquid crystal display device according to Comparative Example 1. In FIG. 4, components, which are the same as those in FIG. 2(A), are represented by the same reference numerals and signs, and the description thereof will be omitted.

The liquid crystal display device according to Comparative Example 1 shown in FIG. 4 is different from the liquid crystal display device according to the present embodiment shown in FIG. 2(A) only in the direction of the director of the liquid crystal molecules 11B. As shown in FIG. 4, in the liquid crystal display device according to Comparative Example 1, in the first domain D1, the alignment regulation angle θt is 270°, and the alignment regulation angle θc is 90°. In the second domain D2, the alignment regulation angle θt is 90°, and the alignment regulation angle θc is 270°. As described above, in the case of the liquid crystal display device according to Comparative Example 1, each of the sub pixels 38L and 38R has the two domains. However, the direction of the director of the liquid crystal molecules 11B in the first domain D1 is in parallel with the direction of the director of the liquid crystal molecules 11B in the second domain D2. Further, the directions of the directors of the liquid crystal molecules 11B are parallel with the boundary line J between the domains.

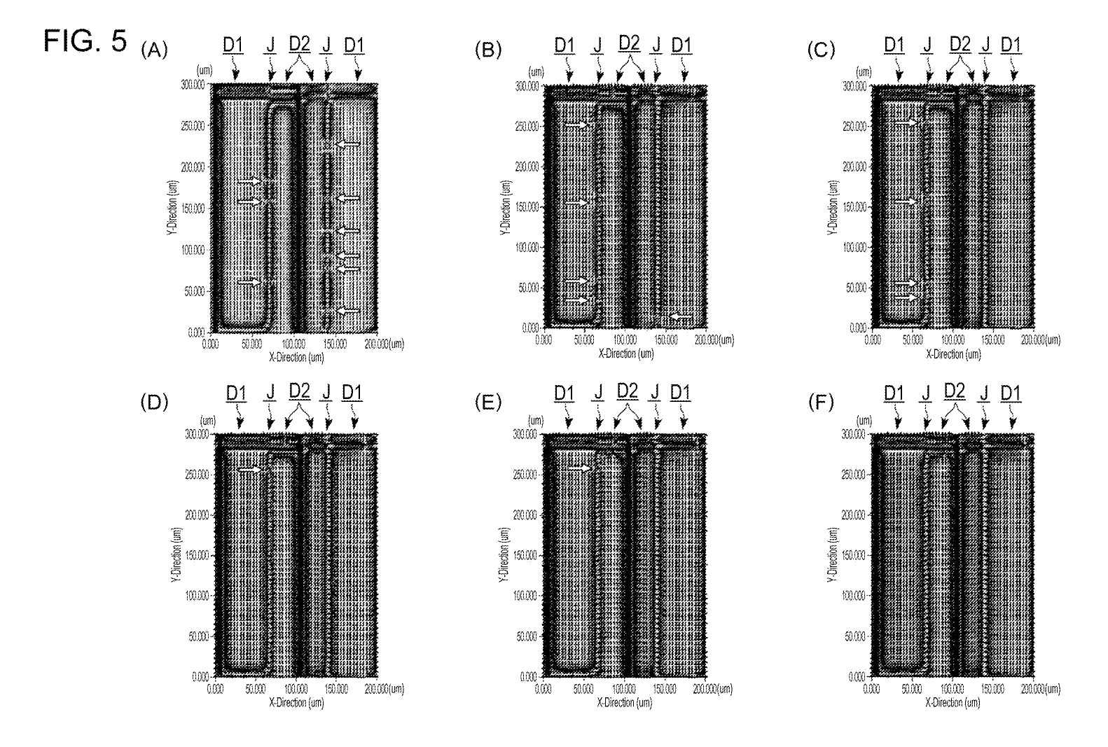

FIGS. 5(A) to 5(F) are diagrams illustrating the simulation results of the alignment states of the liquid crystal molecules to which a voltage is applied, in the liquid crystal display device according to the present embodiment and the liquid crystal display device according to Comparative Example 1.

FIG. 5(A) shows a simulation result of the liquid crystal display device according to Comparative Example 1.

FIGS. 5(B) to 5(F) show simulation results of the liquid crystal display device according to the present embodiment, and show results when the alignment regulation angles of the alignment films are respectively changed in a range of the present embodiment.

In FIG. 5(B), the alignment regulation angle θt of the first domain D1 was set to 271°, and the alignment regulation angle θc of the first domain D1 was set to 91°. That is, the direction of the director of the liquid crystal molecules 11B in the first domain D1 is the 91°-271° direction. Further, the alignment regulation angle θt of the second domain D2 was set to 89°, and the alignment regulation angle θc of the second domain D2 was set to 269°. That is, the direction of the director of the liquid crystal molecules 11B in the second domain D2 is the 89°-269° direction. Accordingly, the angle formed between the director direction of the liquid crystal molecules 11B in the first domain D1 and the director direction of the liquid crystal molecules 11B in the second domain D2 is 2° (±1° with respect to the boundary line J). This liquid crystal display device is assumed to be a liquid crystal display device according to Example 1.

Likewise, in FIG. 5(C), the direction of the director of the liquid crystal molecules 11B in the first domain D1 is the 92°-272° direction. The direction of the director of the liquid crystal molecules 11B in the second domain D2 is the 88°-268° direction. Accordingly, the angle formed between the director direction of the liquid crystal molecules 11B in the first domain D1 and the director direction of the liquid crystal molecules 11B in the second domain D2 is 4° (±2° with respect to the boundary line J). The liquid crystal display device is assumed to be a liquid crystal display device according to Example 2.

Likewise, in FIG. 5(D), the direction of the director of the liquid crystal molecules 11B in the first domain D1 is the 93°-273° direction. The direction of the director of the liquid crystal molecules 11B in the second domain D2 is the 87°-267° direction. Accordingly, the angle formed between the director direction of the liquid crystal molecules 11B in the first domain D1 and the director direction of the liquid crystal molecules 11B in the second domain D2 is 6° (±3° with respect to the boundary line J). The liquid crystal display device is assumed to be a liquid crystal display device according to Example 3.

Likewise, in FIG. 5(E), the direction of the director of the liquid crystal molecules 11B in the first domain D1 is the 95°-275° direction. The direction of the director of the liquid crystal molecules 11B in the second domain D2 is the 85°-265° direction. Accordingly, the angle formed between the director direction of the liquid crystal molecules 11B in the first domain D1 and the director direction of the liquid crystal molecules 11B in the second domain D2 is 10° (±5° with respect to the boundary line J). The liquid crystal display device is assumed to be a liquid crystal display device according to Example 4.

Likewise, in FIG. 5(F), the direction of the director of the liquid crystal molecules 11B in the first domain D1 is the 100°-280° direction. The direction of the director of the liquid crystal molecules 11B in the second domain D2 is the 80°-260° direction. Accordingly, the angle formed between the director direction of the liquid crystal molecules 11B in the first domain D1 and the director direction of the liquid crystal molecules 11B in the second domain D2 is 20° (±10° with respect to the boundary line J). The liquid crystal display device is assumed to be a liquid crystal display device according to Example 5.

That is, in order from FIGS. 5(A), 5(B), 5(C), 5(D), 5(D), 5(E), and 5(F), the director direction of the liquid crystal molecules 11B in the first domain D1 and the director direction of the liquid crystal molecules 11B in the second domain D2 changes from the state, in which the two director directions are parallel with each other, such that difference between the two director directions increases.

In all the simulation results, disclination of the liquid crystal molecules occurs along the boundary line J between the domains, and the low transmittance region, which is shown as a black region in the drawing, is formed in a stripe shape. Further, in the liquid crystal display device according to Comparative Example 1, as shown in FIG. 5(A), there were multiple singularities (locations indicated by the arrows) located along the low transmittance regions.

In contrast, in the liquid crystal display devices according to Examples 1 to 5, as shown in FIGS. 5(B) to 5(F), the number of singularities (locations indicated by the arrows) is reduced, compared with that in Comparative Example 1. In particular, in Examples 3 and 4 (refer to FIGS. 5(D) and 5(E)) in which the angles between the directions of the directors of the liquid crystal molecules 11B in the two domains D1 and D2 are respectively 6° and 10°, the number of singularities is greatly reduced to one. Here, due to the effect of a strong horizontal electric field applied to the vicinity of the gate bus line of the first sub pixel 38L, one singularity remains in this region. Furthermore, in Example 5 (refer to FIG. 5(F)) in which the angle between the directions of the directors of the liquid crystal molecules 11B in the two domains D1 and D2 is 20°, the singularities disappear.

In the VA-mode liquid crystal display device, an optical transmittance is represented by the following Expression (1). In the present embodiment, in consideration of the effect given to the optical transmittance by change in the alignment direction of the liquid crystal molecules 11B, in the following Expression (1), the following assumptions are made. Only the angle θ, which is formed between the transmission axis of the polarization plate and the director direction of the liquid crystal molecules, changes, and the refractive index anisotropy Δn of the liquid crystal, the thickness d of the liquid crystal, and the wavelength λ of light are constant. In this case, the effect given to the optical transmittance by the change in the alignment direction of the liquid crystal molecules 11B is represented by the following Expression (2).

$$\begin{matrix}[ Numerical Expression 1 ] & \\ I = {I}_{0} \cdot {sin}^{2} ( 2 \cdot θ ) \cdot {sin}^{2} ( \frac{Δ n \cdot d \cdot π}{λ} ) & ( 1 ) \\ [ Numerical Expression 2 ] & \\ I ∝ {I}_{0} \cdot {sin}^{2} ( 2 \cdot θ ) & ( 2 )\end{matrix}$$

It is assumed that the transmission axes of the pair of polarization plates are arranged in a cross-nicol manner so as to be in the 45°-225° direction and the 135°-315° direction in FIGS. 5(A) to 5(F). In this case, the optical transmittance of the liquid crystal display device according to Comparative Example 1 in FIG. 5(A) is a maximum, where the angle formed between the transmission axis of the polarization plate and the direction of the director of the liquid crystal molecules is 45°. The liquid crystal display devices according to Examples 1 to 5 in FIGS. 5(B) to 5(F) are inferior to the liquid crystal display device according to Comparative Example 1. Further, as the difference between the directions of the directors of the liquid crystal molecules in the two domains increases, the angle formed between the transmission axis of the polarization plate and the direction of the director of the liquid crystal molecules becomes different from 45°. Hence, the optical transmittance decreases.

When the optical transmittance is calculated on the basis of Expression (2) mentioned above, assuming that the optical transmittance in Comparative Example 1 is 100%, the optical transmittance in Example 4 of FIG. 5(E) is 96.98%, and the optical transmittance in Example 5 of FIG. 5(F) is 88.30%. That is, an amount of decrease in the optical transmittance in Example 4 is −3.02%, and an amount of decrease in the optical transmittance in Example 5 of FIG. 5(F) is −11.70%. When the optical transmittance decreases by such an amount, it is possible to minimize the adverse effect obtained by the change in the alignment direction of the liquid crystal molecules.

In consideration of the simulation results of FIGS. 5(A) to 5(F) and the calculation results of the optical transmittance, it was found that, in order to reduce the number of singularities without such a decrease in the optical transmittance, the angle formed between the directions of the directors of the liquid crystal molecules in the two domains is preferably equal to or greater than 6° and equal to or less than 20°.

Hereinafter, the simulation results will be described in more detail.

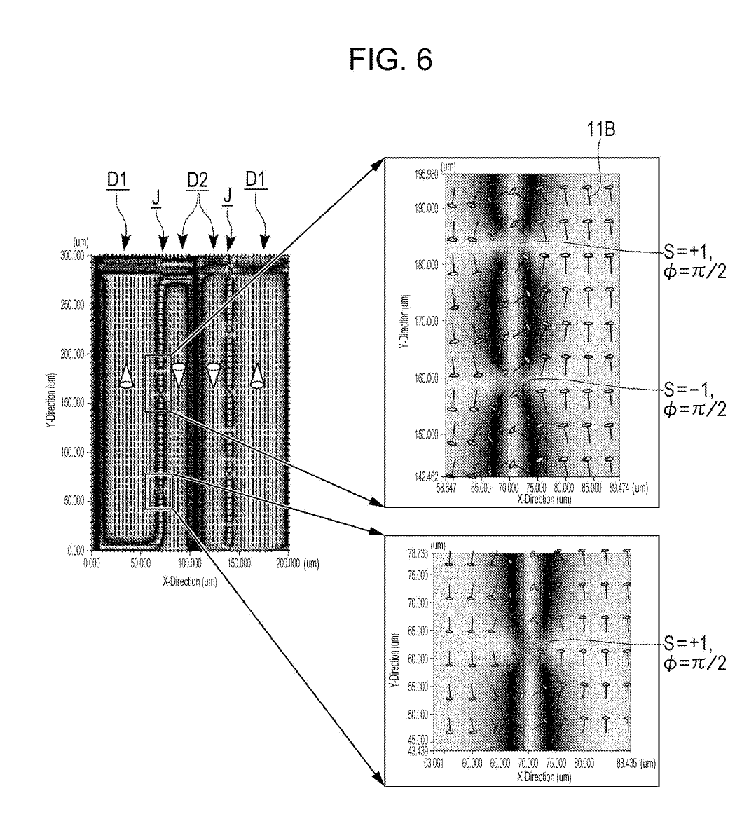

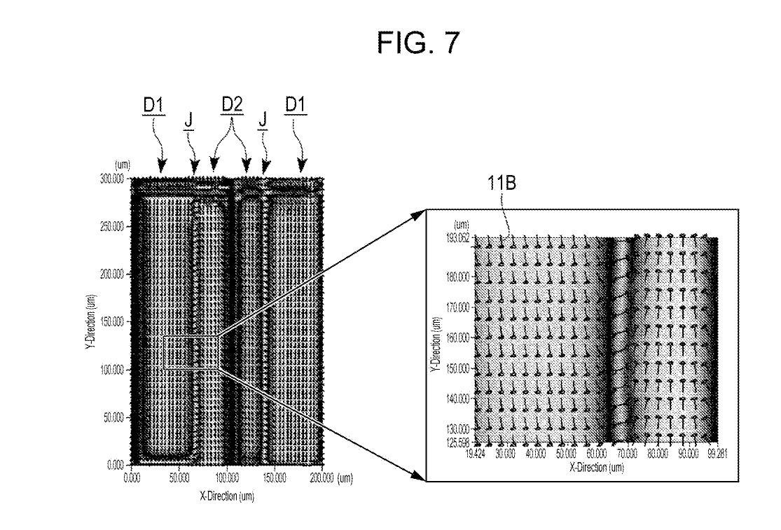

FIG. 6 is an enlarged view of the vicinities of three singularities of the first sub pixel 38L in the simulation result of Comparative Example 1 shown in FIG. 5(A). FIG. 7 is an enlarged view of the region, in which there are no singularities, in the first sub pixel 38L in the simulation result of Example 4 shown in FIG. 5(E).

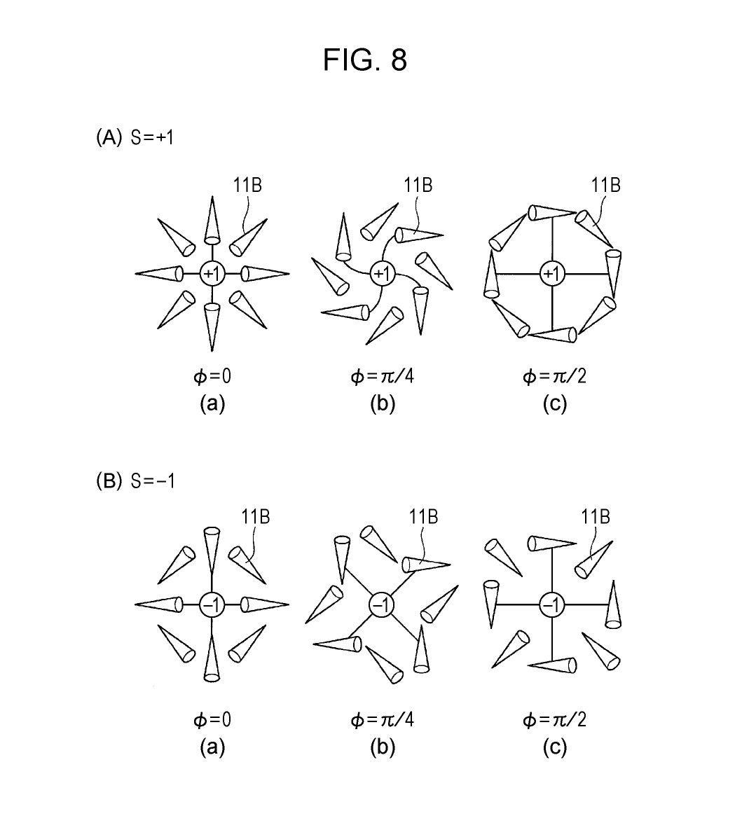

As shown in (a) to (c) of FIG. 8(A) and (a) to (c) of FIG. 8(B), there are several types of singularities in accordance with the alignment states of the liquid crystal molecules 11B. (a) to (c) of FIG. 8(A) and (a) to (c) of FIG. 8(B) are schematic plan views of the alignment states of the liquid crystal molecules 11B as viewed from the direction of the line normal to the liquid crystal panel.

The singularities include: a singularity which is referred to as a first singularity shown in (a) to (c) of FIG. 8(A); and a singularity which is referred to as a second singularity shown in (a) to (c) of FIG. 8(B). The first singularity is a singularity which is in an alignment state where one ends of all the liquid crystal molecules 11B are basically oriented toward the same point. The second singularity is a singularity which is in an alignment state where one ends of the liquid crystal molecules 11B arranged along an arbitrary direction are basically oriented toward the same point but one ends of the other liquid crystal molecules, for example the liquid crystal molecules arranged along a direction orthogonal to the arbitrary direction, are not oriented toward the same point. In the drawings, the first singularity is denoted by +1, and the second singularity is denoted by −1.

Furthermore, the first singularities shown in (a) to (c) of FIG. 8(A) include singularities of which angles φ are different. The angle φ is an angle formed between the director of the liquid crystal molecules 11B and an axis connecting the +1 singularity and the liquid crystal molecules 11B. For example, (a) of FIG. 8(A) is a singularity which is in an alignment state where φ=0, (b) of FIG. 8(A) is a singularity which is in an alignment state where φ=π/4, and (c) of FIG. 8(A) is a singularity which is in an alignment state where φ=π/2. As described above, when the angle φ is larger, the liquid crystal molecules 11B are arranged to be more perfectly rounded around the singularity.

Likewise, the second singularities shown in (a) to (c) of FIG. 8(B) include singularities of which angles φ are different. The angle φ is an angle formed between the director of the liquid crystal molecules 11B and an axis connecting the −1 singularity and the liquid crystal molecules 11B. For example, (a) of FIG. 8(B) is a singularity which is in an alignment state where φ=0, (b) of FIG. 8(B) is a singularity which is in an alignment state where φ=π/4, and (c) of FIG. 8(B) is a singularity which is in an alignment state where φ=π/2.

In the case of the liquid crystal display device according to Comparative Example 1, as shown in FIG. 6, the first singularities (S=+1) and the second singularities (S=−1) alternately occur along the low transmittance regions. This point is the same as that of the MVA-mode liquid crystal display device in the related art. However, in terms of the first singularity (S=+1), the MVA-mode liquid crystal display device in the related art is greatly different from the liquid crystal display device according to Comparative Example 1 in the following point. In the related art, there is a singularity of φ=0, but in Comparative Example 1, there is a singularity of φ=π/2.

In contrast, in the case of the liquid crystal display device according to Example 4, as shown in FIG. 7, there are no singularities except one location in the vicinity of the gate bus line of the first sub pixel 38L. As shown on the right side of FIG. 7, in the enlarged view of the low transmittance region at the location where there are no singularities, it was found that the liquid crystal molecules 11B are aligned in arc shapes on the basis of the directions of the directors of the liquid crystal molecules 11B respectively regulated in the domains placed on the right and left sides. Conversely, when a singularity is intended to be formed from this state, the liquid crystal molecules 11B have to be aligned in arc shapes in opposite directions. In this case, the elastic energy of the liquid crystal alignment increases. Consequently, in the liquid crystal display device according to Example 4, the singularities are unlikely to occur, compared with the liquid crystal display device according to Comparative Example 1.

Next, the inventors of the present invention verified again whether or not the problem can be solved using the MVA technique in the related art. The results will be described.

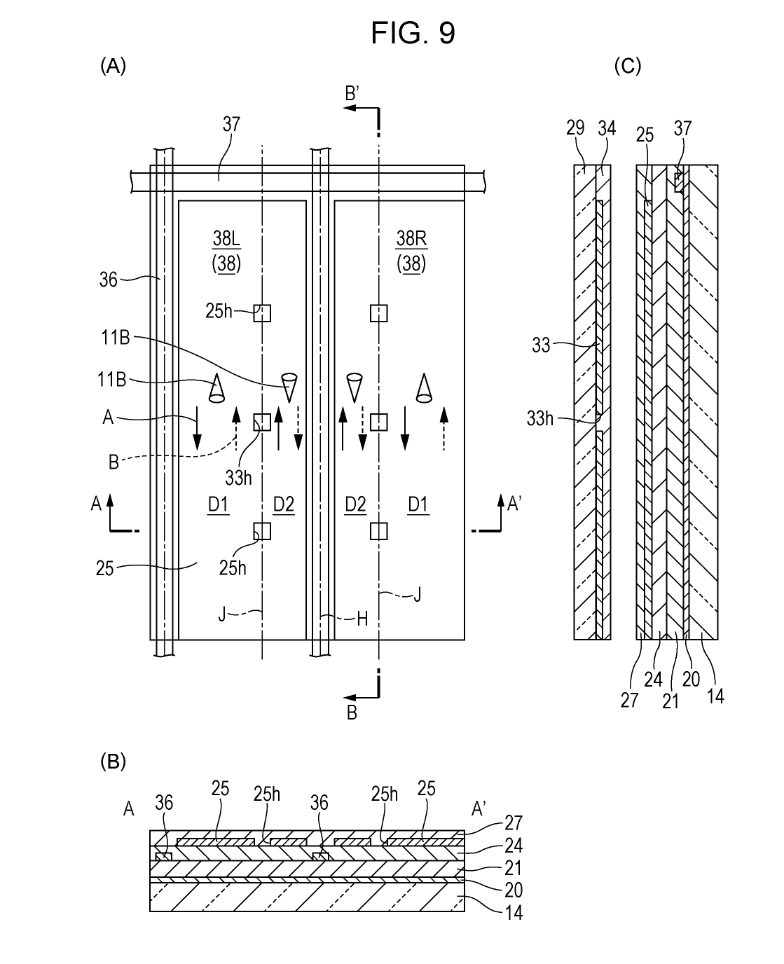

FIG. 9(A) is a plan view illustrating the two sub pixels adjacent to each other in a liquid crystal display device using the MVA technique in the related art. FIG. 9(B) is a cross-sectional view taken along the line A-A′ of FIG. 9(A). FIG. 9(C) is a cross-sectional view taken along the line B-B′ of FIG. 9(A). The liquid crystal display devices shown in FIGS. 9(A) to 9(C) are referred to as a liquid crystal display device according to Comparative Example 2.

In the liquid crystal display device according to Comparative Example 2, as shown in FIG. 9(A), openings 25h and 33h are respectively provided on the pixel electrodes 25 and the counter electrode 33 as alignment regulation means of the liquid crystal molecules 11B. The total three openings 25h and 33h are arranged along the boundary line J between the two domains. The two upper and lower openings 25h are openings provided on the pixel electrodes 25 shown in FIG. 9(B). The one central opening 33h is an opening provided on the counter electrode 33 shown in FIG. 9(C). Both of the dimensions of the openings 25h and 33h are 10 μm square. The directions of the directors of the liquid crystal molecules 11B in the two domains D1 and D2 are the same as those of the liquid crystal display device according to Comparative Example 1.

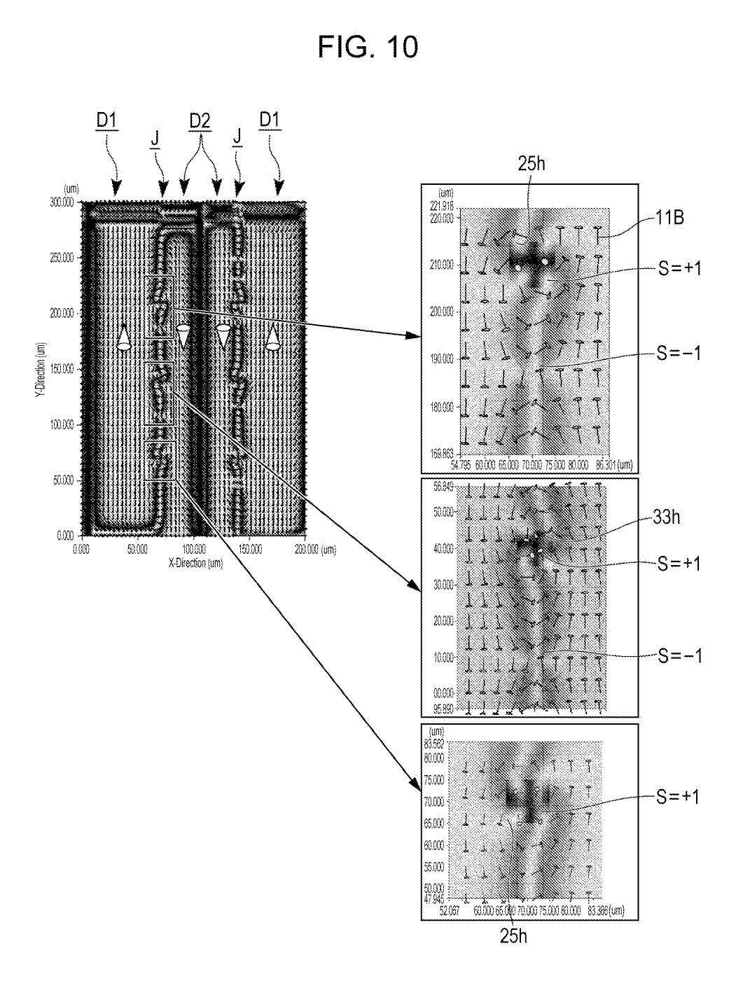

FIG. 10 is a diagram illustrating simulation results of the alignment states of the liquid crystal molecules to which a voltage is applied, in the liquid crystal display device according to Comparative Example 2.

In the liquid crystal display device according to Comparative Example 2, the first singularities (S=+1) occurred at the positions of the openings 25h of the pixel electrodes 25 and the opening 33h of the counter electrode 33. Further, the second singularities (S=−1) occurred at the positions between the openings 25h of the pixel electrodes 25 and the opening 33h of the counter electrode 33. However, it was found that the positions of the second singularities (S=−1) are not fixed. As described above, in the liquid crystal display device according to Comparative Example 2, the singularities are not eliminated, and the positions of the singularities cannot be fixed.

When the conventional alignment regulation means such as the above-mentioned openings of the electrodes or protrusions were used, it was possible to obtain only the effect that the directions of the directors of the liquid crystal molecules 11B are oriented vertically with respect to the boundary line J between the domains.

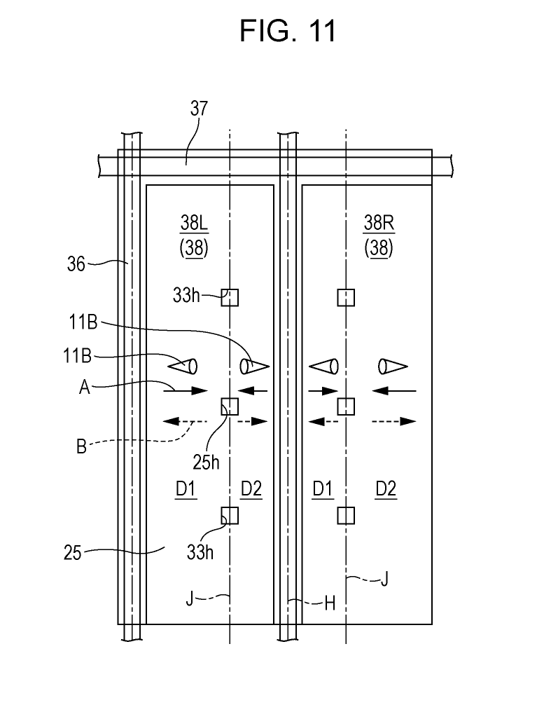

FIG. 11 is a plan view illustrating the two sub pixels adjacent to each other in the liquid crystal display device in which the directions of the directors of the liquid crystal molecules 11B are oriented vertically with respect to the boundary line J between the domains. The liquid crystal display device shown in FIG. 11 is referred to as a liquid crystal display device according to Comparative Example 3.

In the liquid crystal display device according to Comparative Example 3, as shown in FIG. 11, two upper and lower openings 33h are openings provided on the counter electrode 33. One central opening 25h is an opening provided on the pixel electrode 25. Both of the dimensions of the openings 33h and 25h are 10 μm square.

The alignment regulation angle θt of the first domain D1 was set to 0°, and the alignment regulation angle θc of the first domain D1 was set to 180°. That is, the director direction of the liquid crystal molecules 11B in the first domain D1 is the 0°-180° direction. The alignment regulation angle θt of the second domain D2 was set to 180°, and the alignment regulation angle θc of the second domain D2 was set to 0°. That is, the director direction of the liquid crystal molecules 11B in the second domain D2 is the 0°-180° direction. Accordingly, the director direction of the liquid crystal molecules 11B in the first domain D1 is in parallel with the director direction of the liquid crystal molecules 11B in the second domain D2.

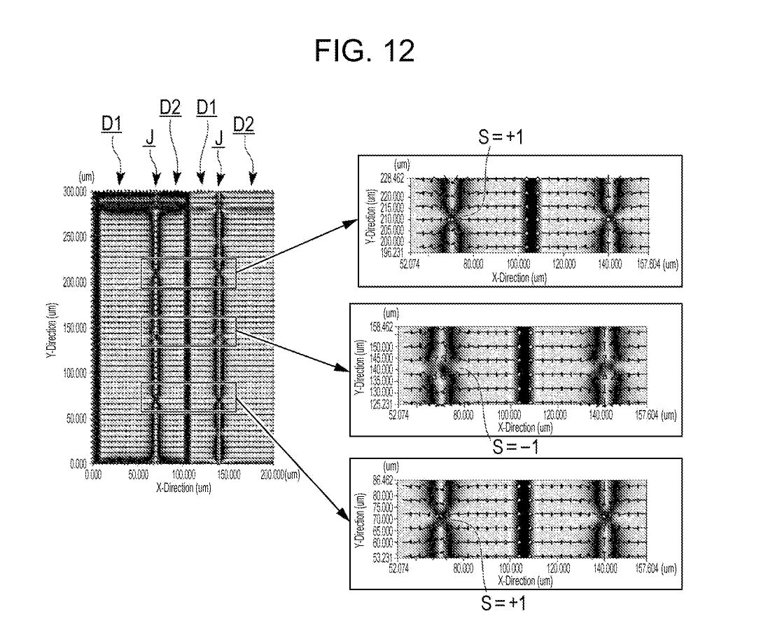

FIG. 12 is a diagram illustrating simulation results of the alignment states of the liquid crystal molecules to which a voltage is applied, in the liquid crystal display device according to Comparative Example 3.

In the liquid crystal display device according to Comparative Example 3, it was found that the first singularities (S=+1) occur at the positions of the two openings 33h of the counter electrode 33 and the second singularity (S=−1) occurs at the position of the opening 25h of the pixel electrode 25. As described above, in the liquid crystal display device according to Comparative Example 3, it is possible to fix the positions of the singularities. However, the singularities cannot be eliminated.

As described above, in the liquid crystal display device 1 according to the present embodiment, the two domains D1 and D2 are provided in one sub pixel 38, and the directions of the directors of the liquid crystal molecules 11B in the two domains D1 and D2 are not parallel. With such a configuration, it is possible to reduce the number of singularities or eliminate the singularities without the alignment regulation means such as the openings of the electrodes or protrusions. In such a manner, without complication of the manufacturing processes, it is possible to embody a liquid crystal display device having excellent display characteristics.

### Second Embodiment

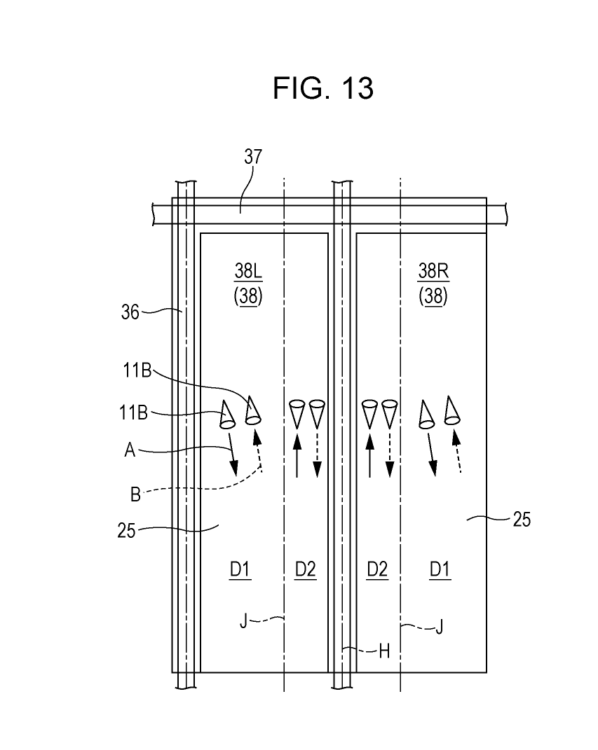

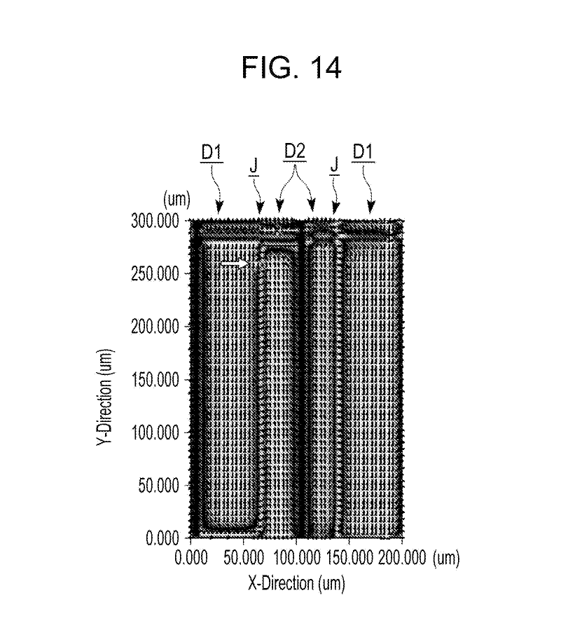

Hereinafter, a second embodiment of the present invention will be described with reference to FIGS. 13 to 14.

A basic configuration of the liquid crystal display device according to the present embodiment is the same as that of the first embodiment except that the directions of the directors of the liquid crystal molecules are different from those of the first embodiment.

FIG. 13 is a plan view illustrating the two sub pixels adjacent to each other in the liquid crystal display device according to the present embodiment. FIG. 14 is a diagram illustrating simulation results of the alignment states of the liquid crystal molecules to which a voltage is applied, in the liquid crystal display device according to the present embodiment.

In FIGS. 13 and 14, the components, which are the same as those in the drawings for the first embodiment, are represented by the same reference numerals and signs, and the description thereof will be omitted.

In the case of the liquid crystal display device according to the present embodiment, as shown in FIG. 13, in the first domain D1, the alignment regulation angle θt is greater than 270° and is equal to or less than 280°, and the alignment regulation angle θc is greater than 90° and is equal to or less than 100°. In contrast, in the second domain D2, the alignment regulation angle θt is 90°, and the alignment regulation angle θc is 270°. That is, in the liquid crystal display device according to the present embodiment, only in the first domain D1, the director direction of the liquid crystal molecules 11B is not in parallel with the boundary line J between the domains. In the second domain D2, the director direction of the liquid crystal molecules 11B is in parallel with the boundary line J between the domains.

FIG. 14 is a diagram illustrating simulation results of the alignment states of the liquid crystal molecules to which a voltage is applied, in the liquid crystal display device according to the present embodiment.

As the simulation conditions, specifically, the following conditions are set: the alignment regulation angle θt of the first domain D1 was set to 275°; and the alignment regulation angle θc of the first domain D1 was set to 95°. That is, the director direction of the liquid crystal molecules 11B in the first domain D1 is the 95°-275° direction. The director direction of the liquid crystal molecules 11B in the second domain D2 is the 90°-270° direction. Accordingly, the angle formed between the director direction of the liquid crystal molecules 11B in the first domain D1 and the director direction of the liquid crystal molecules 11B in the second domain D2 is 5°.

As shown in FIG. 14, also in the present embodiment, similarly to Example 4 (refer to FIG. 5(E)) of the first embodiment, there are no singularities except one location (location indicated by the arrow) in the vicinity of the gate bus line of the first sub pixel 38L. It was found that the liquid crystal molecules 11B are aligned in arc shapes on the basis of the directions of the directors of the liquid crystal molecules 11B respectively regulated in the domains adjacent to each other. Consequently, also in the liquid crystal display device according to the present embodiment, the singularities are unlikely to occur.

The present embodiment also has the same effect as that of the first embodiment in that it is possible to embody a liquid crystal display device having excellent display characteristics without complication of the manufacturing processes.

### Third Embodiment

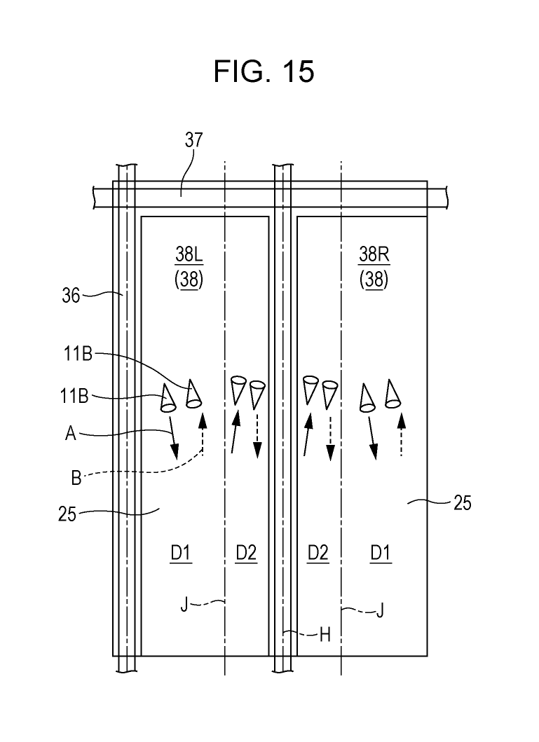

Hereinafter, a third embodiment of the present invention will be described with reference to FIGS. 15 to 17.

A basic configuration of the liquid crystal display device according to the present embodiment is the same as that of the first embodiment except that the directions of the directors of the liquid crystal molecules are different from those of the first embodiment.

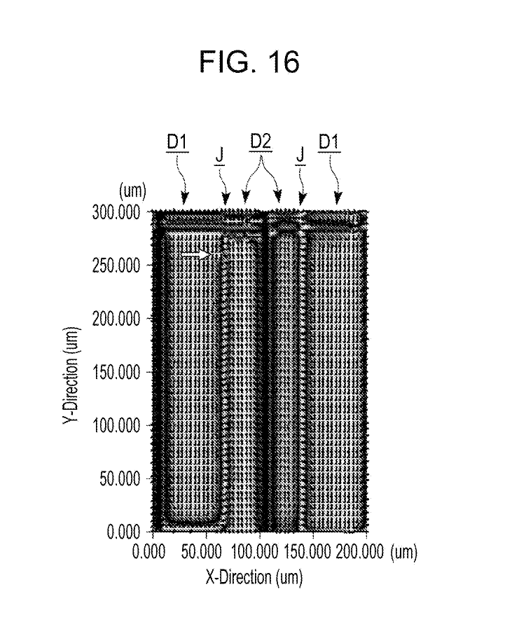

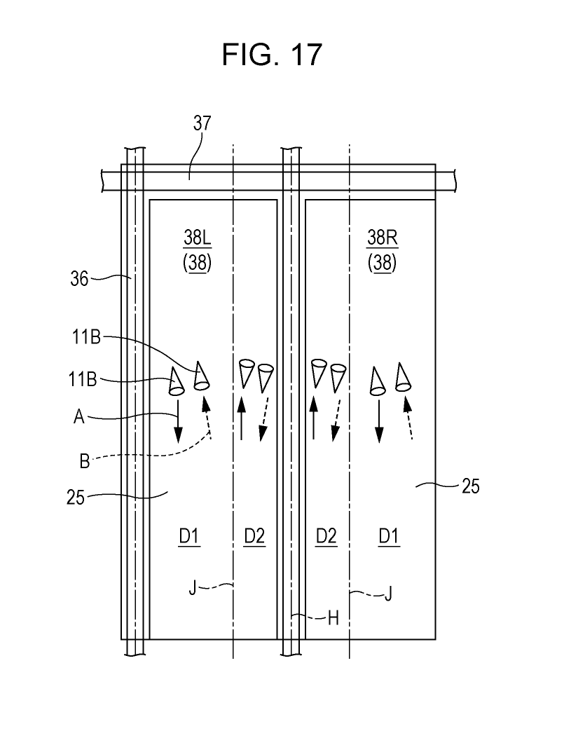

FIG. 15 is a plan view illustrating the two sub pixels adjacent to each other in the liquid crystal display device according to the present embodiment. FIG. 16 is a diagram illustrating simulation results of the alignment states of the liquid crystal molecules to which a voltage is applied, in the liquid crystal display device according to the present embodiment. FIG. 17 is a plan view illustrating the two sub pixels adjacent to each other in the liquid crystal display device according to a modification example of the present embodiment.

In FIGS. 15 to 17, the components, which are the same as those in the drawings for the first embodiment, are represented by the same reference numerals and signs, and the description thereof will be omitted.

The first and second embodiments described the examples of the liquid crystal display devices in which the liquid crystal molecules 11B do not twist. In contrast, the present embodiment will describe an example of the liquid crystal display device in which the liquid crystal molecules 11B twist.

In the case of the liquid crystal display device according to the present embodiment, as shown in FIG. 15, in the first domain D1, the alignment regulation angle θt is greater than 270° and is equal to or less than 280°, and the alignment regulation angle θc is 90°. In contrast, in the second domain D2, the alignment regulation angle θt is equal to or greater than 80° and is less than 90°, and the alignment regulation angle θc is 270°. That is, in the liquid crystal display device according to the present embodiment, in each of the first domain D1 and the second domain D2, the liquid crystal molecules 11B twist with an angle of 10° or less.

FIG. 16 is a diagram illustrating simulation results of the alignment states of the liquid crystal molecules to which a voltage is applied, in the liquid crystal display device according to the present embodiment.

As the simulation conditions, specifically, the following conditions are set: the alignment regulation angle θt of the first domain D1 was set to 280°; and the alignment regulation angle θc of the first domain D1 was set to 90°. That is, the liquid crystal molecules 11B in the first domain D1 twist by 10° in the thickness direction of the liquid crystal layer 11. In this case, the director direction of the liquid crystal molecules 11B in the middle portion of the liquid crystal layer 11 in the thickness direction can be regarded as the 95°-275° direction. Further, the alignment regulation angle θt of the second domain D2 was set to 80°, and the alignment regulation angle θc of the second domain D2 was set to 270°. That is, the liquid crystal molecules 11B in the second domain D2 twist by −10° in the thickness direction of the liquid crystal layer 11. In this case, the director direction of the liquid crystal molecules 11B in the middle portion of the liquid crystal layer 11 in the thickness direction can be regarded as the 85°-265° direction.

As shown in FIG. 16, also in the present embodiment, similarly to Example 4 (refer to FIG. 5(E)) of the first embodiment, there are no singularities except one location (location indicated by the arrow) in the vicinity of the gate bus line of the first sub pixel 38L. It was found that the liquid crystal molecules 11B are aligned in arc shapes on the basis of the director directions of the liquid crystal molecules 11B respectively regulated in the domains D1 and D2 adjacent to each other. Consequently, also in the liquid crystal display device according to the present embodiment, the singularities are unlikely to occur.

In the liquid crystal layer 11, the liquid crystal molecules 11B, which are most likely to move when a voltage is applied thereto, are liquid crystal molecules 11B positioned in the middle portion of the liquid crystal layer 11, which is not regulated by the alignment films 27 and 34 on the substrate surface, in the thickness direction. In the present embodiment, by twisting the liquid crystal molecules 11B, the liquid crystal molecules 11B in the middle portion of the liquid crystal layer 11 in the thickness direction in the two domains D1 and D2 are tilted at an angle. As a result, the present embodiment has the same effects and advantages as those of the first and second embodiments. Thereby, the present embodiment also has the same effect as those of the first and second embodiments in that it is possible to embody a liquid crystal display device having excellent display characteristics without complication of the manufacturing processes.

In the present embodiment, the alignment regulation angle θc on the color filter substrate 10 side was set to be in parallel with the boundary line J between the domains, and the alignment regulation angle θt on the TFT substrate 9 side was set not to be in parallel with the boundary line J between the domains. Instead of this configuration, the alignment regulation angle θt on the TFT substrate 9 side may be set to be in parallel with the boundary line J between the domains, and the alignment regulation angle θc on the color filter substrate 10 side may be set not to be in parallel with the boundary line J between the domains.

In the liquid crystal display device according to the modification example of the present embodiment, as shown in FIG. 17, in the first domain D1, the alignment regulation angle θt is 270°, and the alignment regulation angle θc is greater than 90° and is equal to or less than 100°. In contrast, in the second domain D2, the alignment regulation angle θt is 90°, and the alignment regulation angle θc is equal to or greater than 260° and is less than 270°. That is, in the liquid crystal display device according to the present modification example, in each of the first domain D1 and the second domain D2, the liquid crystal molecules 11B twist by an angle of 10° or less. In the liquid crystal display device according to the present modification example, also the simulation result is substantially the same as that of FIG. 16.

### Fourth Embodiment

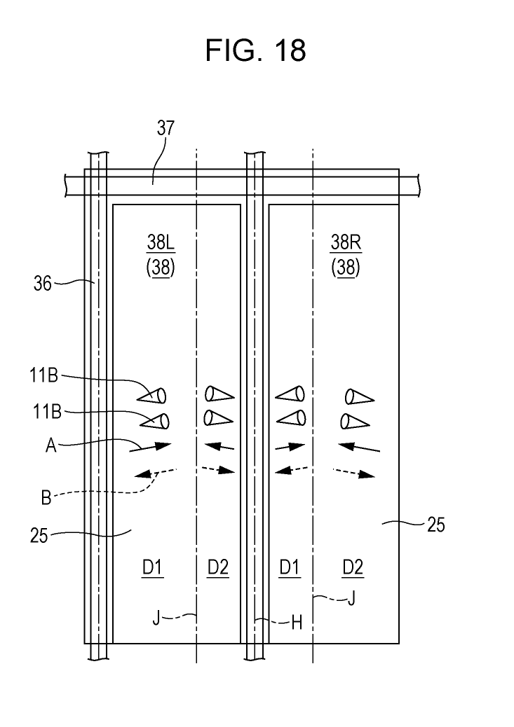

Hereinafter, a fourth embodiment of the present invention will be described with reference to FIGS. 18 to 20.

A basic configuration of the liquid crystal display device according to the present embodiment is the same as that of the first embodiment except that the directions of the directors of the liquid crystal molecules are different from those of the first embodiment.

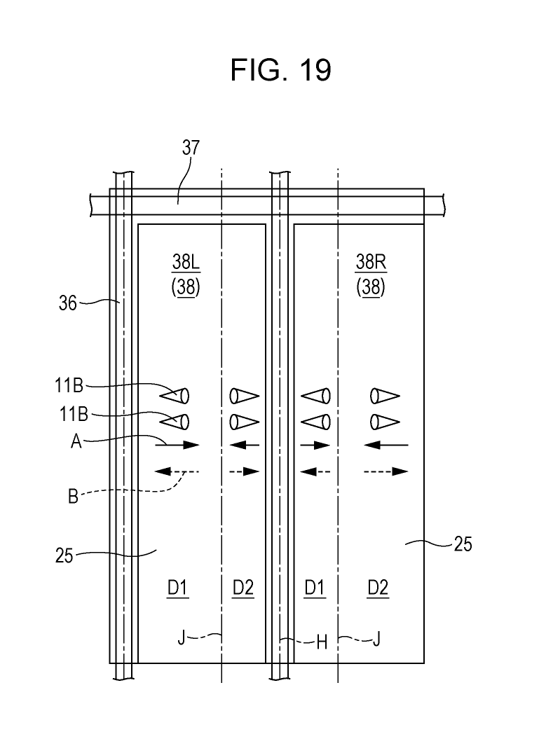

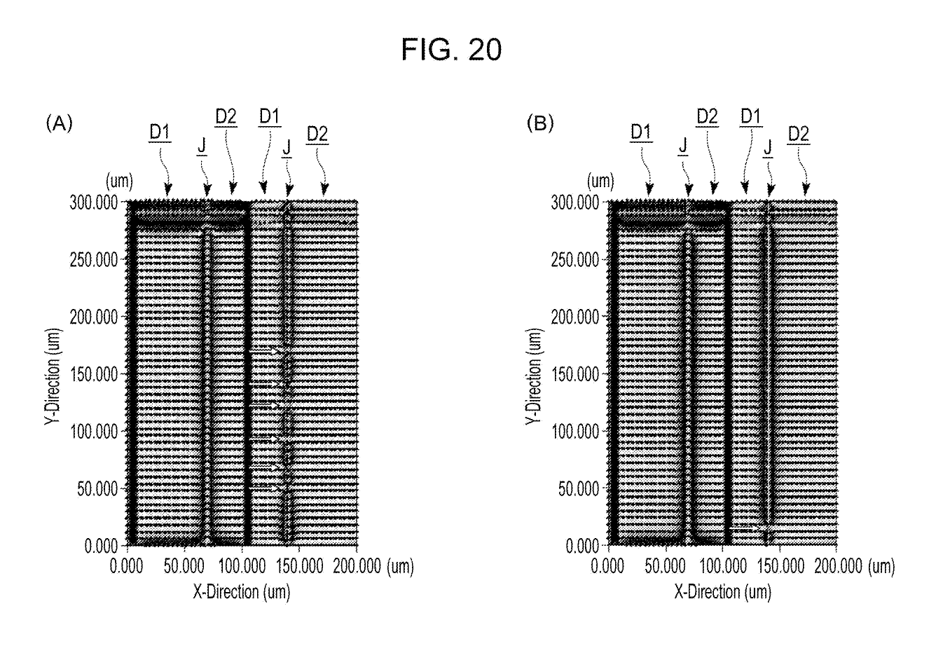

FIG. 18 is a plan view illustrating the two sub pixels adjacent to each other in the liquid crystal display device according to the present embodiment. FIG. 19 is a plan view illustrating the two sub pixels adjacent to each other in the liquid crystal display device according to Comparative Example 4. FIG. 20(A) is a diagram illustrating simulation results of the alignment states of the liquid crystal molecules to which a voltage is applied, in the liquid crystal display device according to Comparative Example 4. FIG. 20(B) is a diagram illustrating simulation results of the alignment states of the liquid crystal molecules to which a voltage is applied, in the liquid crystal display device according to the present embodiment.

In FIGS. 18 to 20, the components, which are the same as those in the drawings for the first embodiment, are represented by the same reference numerals and signs, and the description thereof will be omitted.

In the case of the liquid crystal display device according to the present embodiment, as shown in FIG. 18, in the first domain D1, the alignment regulation angle θt is greater than 0° and is equal to or less than 10°, and the alignment regulation angle θc is greater than 180° and is equal to or less than 190°. In contrast, in the second domain D2, the alignment regulation angle θt is equal to or greater than 170° and is less than 180°, and the alignment regulation angle θc is equal to or greater than 350° and is less than 360°. Thereby, the directions of the directors of the liquid crystal molecules 11B in the two domains D1 and D2 are not parallel.

In the simulation to be described later, in the first domain D1, the alignment regulation angle θt was set to 5°, and the alignment regulation angle θc was set to 185°. At this time, the director direction of the liquid crystal molecules 11B in the first domain D1 is the 5°-185° direction. In contrast, in the second domain D2, the alignment regulation angle θt was set to 175°, and the alignment regulation angle θc was set to 355°. At this time, the director direction of the liquid crystal molecules 11B in the second domain D2 is the 175°-355° direction. Consequently, the angle formed between the director directions of the liquid crystal molecules 11B in the two domains D1 and D2 is 10°.

In contrast, in the liquid crystal display device according to Comparative Example 4, as shown in FIG. 19, in the first domain D1, the alignment regulation angle θt was set to 0°, and the alignment regulation angle θc was set to 180°. At this time, the director direction of the liquid crystal molecules 11B in the first domain D1 is the 0°-180° direction. In contrast, in the second domain D2, the alignment regulation angle θt was set to 180°, and the alignment regulation angle θc was set to 0°. At this time, the director direction of the liquid crystal molecules 11B in the second domain D2 is the 0°-180° direction. That is, the director directions of the liquid crystal molecules 11B in the two domains D1 and D2 are parallel.

As shown in FIG. 20(A), in the case of the liquid crystal display device according to Comparative Example 4, there are multiple singularities (locations indicated by the arrows). In contrast, as shown in FIG. 20(B), in the case of the liquid crystal display device according to the present embodiment, the number of singularities is reduced to one. Also in the present embodiment, it was found that the liquid crystal molecules 11B are aligned in arc shapes on the basis of the director directions of the liquid crystal molecules 11B respectively regulated in the domains D1 and D2 adjacent to each other. Consequently, also in the liquid crystal display device according to the present embodiment, the singularities are unlikely to occur.

The present embodiment also has the same effect as those of the first to third embodiments in that it is possible to embody a liquid crystal display device having excellent display characteristics without complication of the manufacturing processes.

### Fifth Embodiment

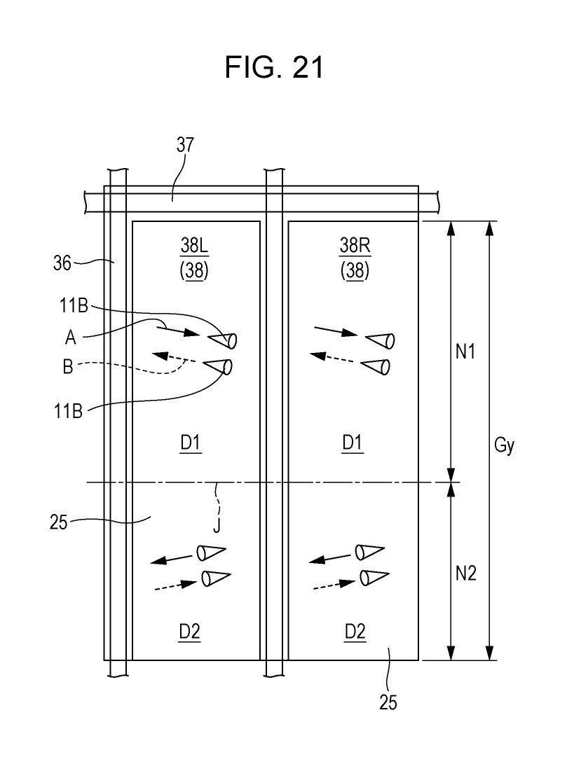

Hereinafter, a fifth embodiment of the present invention will be described with reference to FIGS. 21 to 23.

A basic configuration of the liquid crystal display device according to the present embodiment is the same as that of the first embodiment except that the direction of dividing the domains is different from that of the first embodiment.

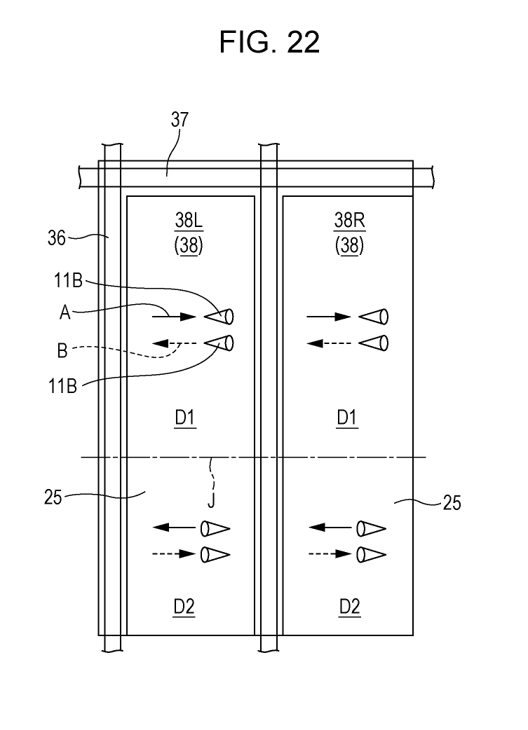

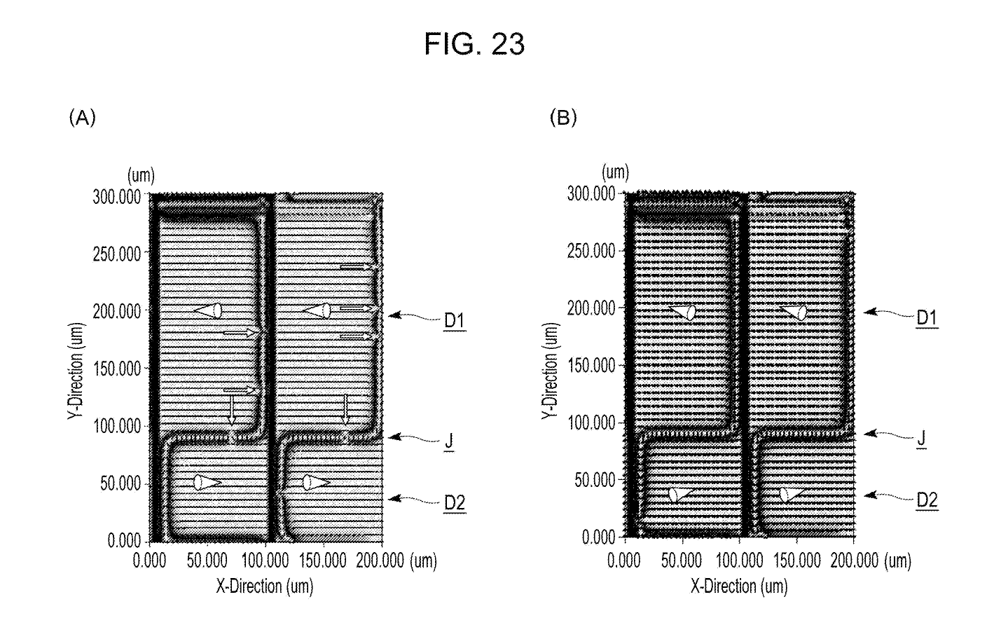

FIG. 21 is a plan view illustrating the two sub pixels adjacent to each other in the liquid crystal display device according to the present embodiment. FIG. 22 is a plan view illustrating the two sub pixels adjacent to each other in the liquid crystal display device according to Comparative Example 5. FIG. 23(A) is a diagram illustrating simulation results of the alignment states of the liquid crystal molecules to which a voltage is applied, in the liquid crystal display device according to Comparative Example 5. FIG. 23(B) is a diagram illustrating simulation results of the alignment states of the liquid crystal molecules to which a voltage is applied, in the liquid crystal display device according to the present embodiment.

In FIGS. 21 to 23, the components, which are the same as those in the drawings for the first embodiment, are represented by the same reference numerals and signs, and the description thereof will be omitted.

The first to fourth embodiments described examples of the liquid crystal display devices in which the boundary line J between the domains extends in the y axis direction and the two domains D1 and D2 in one sub pixel 38 are divided in the x axis direction. In contrast, the present embodiment describes an example of the liquid crystal display device in which the boundary line J between the domains extends in the x axis direction and the two domains D1 and D2 in one sub pixel 38 are divided in the x axis direction.

In the liquid crystal display device according to the present embodiment, as shown in FIG. 21, the boundary line J between the first domain D1 and the second domain D2 extends in the direction (x axis direction) which is in parallel with the gate bus line 37. The first domain D1 and the second domain D2 are arranged in the direction (y axis direction) which is in parallel with the source bus line 36. The boundary line J between the two domains D1 and D2 is at the position shifted from the center of each of the sub pixels 38, and thus the size of the first domain D1 positioned on the pixel electrode 25 is different from the size of the second domain D2. The pixel electrode 25, of which the dimension Gy in the y axis direction (length direction) is 280 μm, is divided into two parts by the boundary line J. For example, the dimension N1 of the first domain D1 in the y axis direction is 190 μm, and the dimension N2 of the second domain D2 in the y axis direction is 90 μm.

In the case of the liquid crystal display device according to the present embodiment, in the first domain D1, the alignment regulation angle θt is equal to or greater than 350° and is less than 360°, and the alignment regulation angle θc is equal to or greater than 170° and is less than 180°. In contrast, in the second domain D2, the alignment regulation angle θt is greater than 180° and is equal to or less than 190°, and the alignment regulation angle θc is greater than 0°, and is equal to or less than 10°. Thereby, the director directions of the liquid crystal molecules 11B in the two domains D1 and D2 are not parallel.

In the simulation to be described later, in the first domain D1, the alignment regulation angle θt was set to 355°, and the alignment regulation angle θc was set to 175°. At this time, the direction of the director of the liquid crystal molecules 11B in the first domain D1 is the 175°-355° direction. In contrast, in the second domain D2, the alignment regulation angle θt was set to 185°, and the alignment regulation angle θc was set to 5°.

At this time, the direction of the director of the liquid crystal molecules 11B in the second domain D2 is the 5°-185° direction. Consequently, the angle formed between the directors of the liquid crystal molecules 11B in the two domains D1 and D2 is 10°.

In contrast, in the liquid crystal display device according to Comparative Example 5, as shown in FIG. 22, in the first domain D1, the alignment regulation angle θt was set to 0°, and the alignment regulation angle θc was set to 180°. At this time, the direction of the director of the liquid crystal molecules 11B in the first domain D1 is the 0°-180° direction. In contrast, in the second domain D2, the alignment regulation angle θt was set to 180°, and the alignment regulation angle θc was set to 0°. At this time, the direction of the director of the liquid crystal molecules 11B in the second domain D2 is the 0°-180° direction. That is, the directions of the directors of the liquid crystal molecules 11B in the two domains D1 and D2 are parallel.

As shown in FIG. 23(A), in the case of the liquid crystal display device according to Comparative Example 5, there are multiple singularities (locations indicated by the arrows) along the low transmittance regions. In contrast, as shown in FIG. 23(B), in the case of the liquid crystal display device according to the present embodiment, the singularities disappear. Also in the present embodiment, it was found that the liquid crystal molecules 11B are aligned in arc shapes on the basis of the directions of the directors of the liquid crystal molecules 11B respectively regulated in the domains D1 and D2 adjacent to each other. Consequently, also in the liquid crystal display device according to the present embodiment, the singularities are unlikely to occur.

The present embodiment also has the same effect as those of the first to fifth embodiments in that it is possible to embody a liquid crystal display device having excellent display characteristics without complication of the manufacturing processes.

### Sixth Embodiment

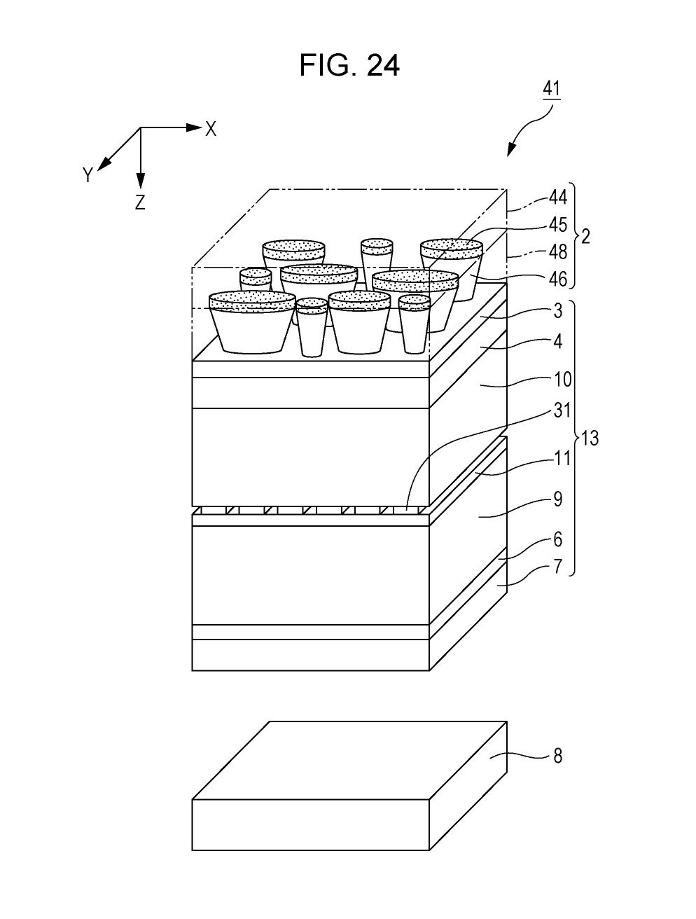

Hereinafter, a sixth embodiment of the present invention will be described with reference to FIGS. 24 to 26.

The liquid crystal display device according to the present embodiment is an example of a liquid crystal display device that has a light diffusion film for improving the angle of view.

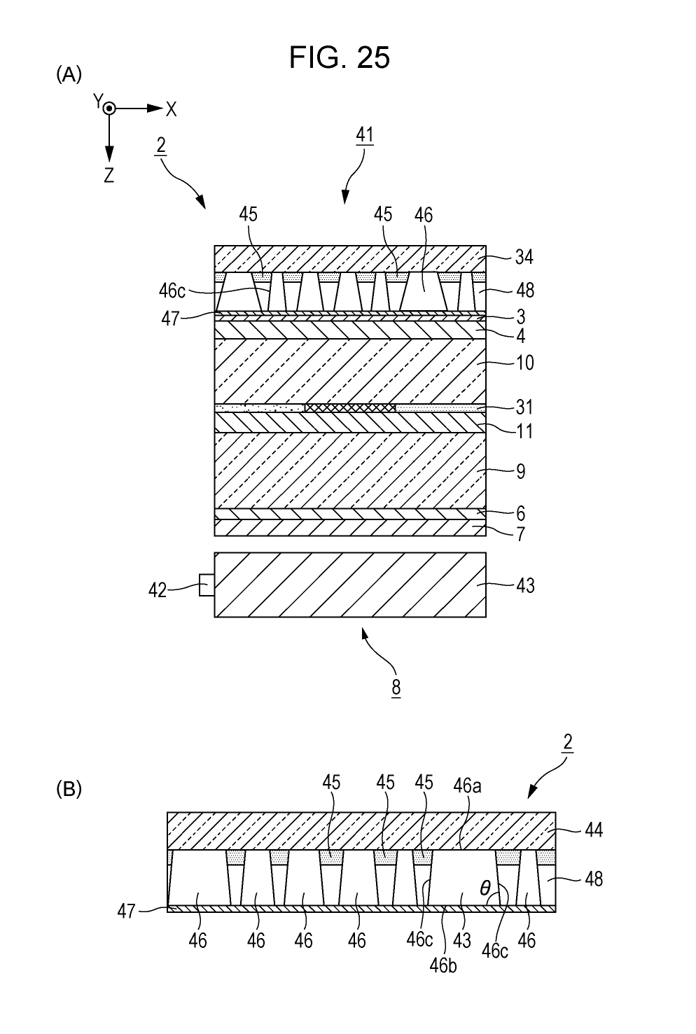

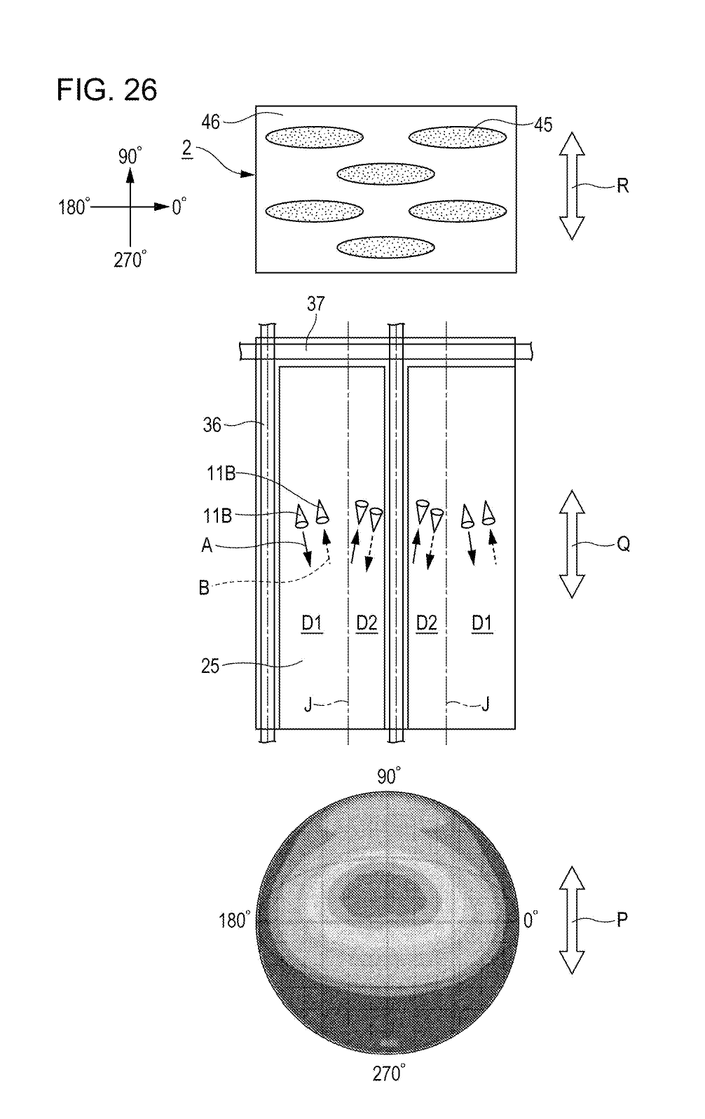

FIG. 24 is a perspective view of the liquid crystal display device according to the present embodiment. FIG. 25(A) is a cross-sectional view of the liquid crystal display device, and FIG. 25(B) is a cross-sectional view of the light diffusion film. FIG. 26 is a diagram illustrating a relationship in arrangement between the backlight, the liquid crystal panel, and the light diffusion film.

In FIGS. 24 to 26, the components, which are the same as those in the drawings for the first embodiment, are represented by the same reference numerals and signs, and the description thereof will be omitted.

The liquid crystal display device 41 according to the present embodiment includes, as shown in FIGS. 24 and 25(A), the backlight 8, the liquid crystal panel 13, and the light diffusion film 2 (light diffusion member). The liquid crystal panel 13 has the first polarization plate 3, the first phase difference plate 4, the TFT substrate 9 and the color filter substrate 10 between which the liquid crystal layer 11 and the color filters 31 are sandwiched, the second phase difference plate 6, and the second polarization plate 7. In FIGS. 1 and 2(A), each of the TFT substrate 9 and the color filter substrate 10 is schematically illustrated as one plate, and the specific structure is as described in the first embodiment (refer to FIG. 1). An observer views the display on the upper side above the liquid crystal display device 41, on which the light diffusion film 2 is disposed, in FIG. 24. Accordingly, in the following description, the side, on which the light diffusion film 2 is disposed, is referred to as a viewing side, and the side, on which the backlight 8 is disposed, is referred to as a rear side.

In the liquid crystal display device 41 according to the present embodiment, light emitted from the backlight 8 is modulated by the liquid crystal panel 13, and predetermined images, characters, and the like are displayed using the modulated light. When the light emitted from the liquid crystal panel 13 is transmitted through the light diffusion film 2, a degree of spread of angles of the emitted light becomes greater than that before incidence into the light diffusion film 2, and the light is emitted from the light diffusion film 2. Thereby, the observer is able to view the display with a wide angle of view.

As shown in FIG. 25(A), the backlight 8 may be an edge-light-type backlight in which a light source 42 such as an LED is disposed on the end face of a light guide 43, and may be a direct backlight in which the light source is directly below the light guide. As the backlight 8, it is preferable to use a backlight which has directivity by controlling a light emission direction, that is, a so-called directional backlight. Blur in the display is reduced using the directional backlight capable of making collimated light incident into a light diffusion portion of the light diffusion film 2 to be described later, and thus it is possible to increase use efficiency of light. Light distribution of the backlight will be described later.

Hereinafter, the light diffusion film 2 will be described in detail.

As shown in FIGS. 24 and 25(B), the light diffusion film 2 includes: a transparent base 44; a plurality of light blocking portions 45 which are formed on one face (face on a side opposite to the viewing side) of the transparent base 44; and a light diffusion portion 46 which is formed on one face of the transparent base 44. As shown in FIG. 25(A), the light diffusion film 2 is fixed by an adhesive layer 47 on the first polarization plate 3 such that a side thereof, on which the light diffusion portion 46 is provided, faces the first polarization plate 3 and a side thereof close to the transparent base 44 faces the viewing side.

As the transparent base 44, it is preferable to use, for example, a transparent resin base such as a triacetyl cellulose (TAC) film, a polyethylene terephthalate (PET) film, a polycarbonate (PC) film, a polyethylene naphthalate (PEN) film, or a polyether sulfone (PES) film. In the manufacturing processes, the transparent base 44 is a base to be coated with a material of the light diffusion portion 46 or the light blocking portion 45. Thus, in a heat treatment process among the manufacturing processes, it is necessary for the base to have heat resistance and mechanical strength. Consequently, as the transparent base 44, not only the base made of resin but also a base made of glass and the like may be used. In the present embodiment, for example, a base made of transparent resin having a thickness of 100 μm is used.

As shown in FIG. 24, a plurality of light blocking portions 45 are formed to be scattered on one face (face on the side opposite to the viewing side) of the transparent base 44. As shown in FIG. 26, in the present embodiment, when the light diffusion film 2 is viewed in the z axis direction, a planar shape of the light blocking portion 45 is an anisotropic shape which is typified by for example an elliptical shape and has a major axis and a minor axis. That is, the size of the shape of the light blocking layer 45 in the direction of the azimuth angle 0°-180° is large, and the size thereof in the direction of the azimuth angle 90°-270° is small.

Hence, in a cross-sectional view of the light diffusion film 2, a lateral area of the light diffusion portion 46 in the direction of the azimuth angle 0°-180° is smaller than a lateral area of the light diffusion portion 46 in the direction of the azimuth angle 90°-270°. Consequently, in the light diffusion film 2, an amount of light, which is diffused and emitted in the direction of the azimuth angle 0°-180°, is relatively small, and an amount of light, which is diffused and emitted in the direction of the azimuth angle 90°-270°, is relatively large. That is, an anisotropic light-diffusing property is achieved depending on the azimuth orientation.

In FIG. 26, the sizes of the light blocking portions 45 are illustrated as being equal, but the light blocking portions 45 are not particularly limited to having predetermined dimensions, and there may be light blocking portions 45 having various dimensions. Further, the arrangement of the light blocking portions 45 is not limited to regular arrangement, and is also not limited to periodic arrangement. That is, the light blocking portions 45 may be randomly arranged. The light blocking portions 45 adjacent to each other may be formed to overlap with each other.

The light blocking portions 45 are formed as a layer made of black pigment, dye, resin, or the like having a light absorbing property and photosensitivity such as a black resist containing carbon black. When a resin containing carbon black or the like is used, a film forming the light blocking portions 45 can be formed by a printing process. Hence, it is possible to obtain advantages in that the material usage is less and the throughput is high. Otherwise, a metal film such as a chromium (Cr) film or a multilayer film formed of Cr/Cr-oxide may be used. In a case of using such a metal film or a multilayer film, the optical density of such a film is high, and thus there is an advantage in that a thin film sufficiently absorbs light.

The light diffusion portion 46 is formed of, for example, an organic material, such as acryl resin or epoxy resin, having optical transparency and photosensitivity. The thickness of the light diffusion portion 46 is set to be sufficiently larger than the thickness of the light blocking portion 45. In the case of the present embodiment, the thickness of the light diffusion portion 46 is, for example, approximately 25 μm, and the thickness of the light blocking portion 45 is, for example, approximately 150 nm.

In a region where the light blocking portions 45 are formed on one face of the transparent base 44, hollow portions 48 are formed in the following shape: an area of a cross-section of each hollow portion 48, which is cut along a plane parallel with one face of the transparent base 39, is larger at a position closer to the light blocking portions 45, and is smaller at a position further from the light blocking portions 45. That is, as viewed from the transparent base 44, the hollow portion 48 has a circular truncated cone shape, that is, a so-called forward tapered shape. Air is present in the hollow portion 48. The light diffusion portion 46 is a region in which a transparent resin continuously extends, and contributes to light transmission. The light, which is incident into the light diffusion portion 46, is totally reflected by a side surface 46c of the light diffusion portion 46, that is, an interface between the light diffusion portion 46 and the hollow portion 48, travels inside the light diffusion portion 46, and is emitted to the outside through the transparent base 44.

In the case of the present embodiment, air is present in the hollow portion 48. Hence, when the light diffusion portion 46 is formed of for example transparent acryl resin, the side surface 46c of the light diffusion portion 46 is formed as the interface between the transparent acryl resin and the air. Here, regarding a difference in refractive index at the interface between the inside and the outside of the light diffusion portion 46, the difference, which is obtained in a case where the hollow portions 48 are filled with air, is larger than that in a different general case where the hollow portions 48 are filled with a low refractive index material. Accordingly, in the case of the present embodiment, due to Snell's law, the incident angle range of the light, at which there is total reflection by the side surface 46c of the light diffusion portion 46, increases. As a result, by further suppressing light loss, it is possible to obtain a high luminance.

It should be noted that the hollow portions 48 may be filled with inert gas such as nitrogen instead of air. Alternatively, the inside of each hollow portion 48 may be depressurized.

As shown in FIG. 25(B), between two counter faces of the light diffusion portion 46, a face (face on a side that is in contact with the transparent base 44) having a smaller area is a light emission end face 46a, and a face (face on a side that is opposite to the transparent base 44) having a larger area is a light incidence end face 46b. It is preferable that an inclination angle θ (angle formed between the light incidence end face 46b and the side surface 46c) of the side surface 46c (the interface between the light diffusion portion 46 and the hollow portion 48) of the light diffusion portion 46 be approximately 60° to 90°. However, the inclination angle of the side surface 46c of the light diffusion portion 46 is not particularly limited if the angle is an angle capable of sufficiently diffusing incident light without great incident light loss.

In the case of the present embodiment, the light blocking portions 45, which have the light observing property, are provided in a region other than the light diffusion portion 46. Hence, without total reflection, the light, which is transmitted through the side surface 46c of the light diffusion portion 46, is absorbed by the light blocking portions 45. Thereby, there is no concern about blur in display caused by stray light and the like and deterioration in the contrast. Meanwhile, if the amount of light transmitted through the side surface 46c of the light diffusion portion 46 increases, the amount of light emitted to the viewing side decreases, and thus it is possible to obtain an image of which the luminance is high. Therefore, in the liquid crystal display device 41 according to the present embodiment, it is preferable to use a backlight that emits light at an angle such that the light is not incident onto the side surface 46c of the light diffusion portion 46 at a critical angle or less, that is, a so-called directional backlight.

In the liquid crystal display device 41 having the above configuration, the relationship in arrangement between the backlight 8, the liquid crystal panel 13, and the light diffusion film 2 will be described.

Generally, in the VA-mode liquid crystal display device, a technique of forming four domains, of which the directions of the directors of the liquid crystal molecules are orthogonal to each other, is well known, and has also been used in mass production. In the following description, the technique is referred to as a 4-domain technique. Meanwhile, as described in the first to fifth embodiments, a technique of forming two domains, of which the directions of the directors of the liquid crystal molecules are opposite to each other, has hitherto not been used in mass production. The technique is referred to as a 2-domain technique. The reason is based on the following two points: the 4-domain technique is more advantageous in omnidirectional viewing angle characteristics than the 2-domain technique; and the liquid crystal display device using the 4-domain technique is more advantageous in manufacturing than the liquid crystal display device using the 2-domain technique.

However, recently, due to the development of the above-mentioned light diffusion film, the inventors of the present invention found that the liquid crystal display device using the 2-domain technique has better viewing angle characteristics than the liquid crystal display device using the 4-domain technique if the liquid crystal display device using the 2-domain technique is combined with the light diffusion film. That is, the liquid crystal display device using the 4-domain technique has viewing angle characteristics substantially the same in four directions, while the liquid crystal display device using the 2-domain technique has viewing angle characteristics superior to those in the 4-domain technique in terms of only two directions but has inferior viewing angle characteristics in terms of the remaining two directions. Therefore, by using the light diffusion film having the anisotropic light-diffusing property, the inferior viewing angle characteristics in the two directions are corrected. Thereby, it is possible to achieve viewing angle characteristics excellent in all directions.

Specifically, as shown on the lower side of FIG. 26, the backlight 8 is disposed. The backlight 8 has light distribution where change in the luminance in the 0°-180° direction is gentle and the change in the luminance in the 90°-270° direction is steep. In other words, the backlight 8 is disposed such that a direction (direction indicated by the arrow P), in which the directivity of the emitted light is high, is oriented in the 90°-270° direction. In contrast, as shown in the center of FIG. 26, similarly to the first embodiment in FIG. 2(A), the liquid crystal panel 13 is disposed such that the boundary line J between the two domains D1 and D2 is in parallel with the 90°-270° direction. In this case, a degree of change in the optical transmittance in the 90°-270° direction (direction indicated by the arrow Q) is greater than that in the 0°-180° direction. Therefore, as shown on the upper side of FIG. 26, the light diffusion film 2 is disposed such that the major axis direction of the light blocking portion 45 is oriented in the 0°-180° direction and the minor axis direction of the light blocking portion 45 is oriented in the 90°-270° direction (direction indicated by the arrow R).

That is, the diffusion intensity of the light diffusion film 2 is different in accordance with the azimuth angle direction, and the azimuth angle direction (direction indicated by the arrow R), in which the change in the diffusion intensity is relatively large, substantially coincides with the azimuth angle direction (direction indicated by the arrow Q) in which the change in the transmittance of the liquid crystal panel 13 is relatively large. When the light diffusion film 2 is disposed in such a manner, a proportion of the light diffused in the 90°-270° direction is greater than a proportion of the light diffused in the 0°-180° direction. As a result, the steep change in the optical transmittance in the 90°-270° direction becomes gentle, and viewing angle characteristics excellent in all the directions are achieved.

As described above, according to the present embodiment, it is possible to embody a liquid crystal display device of which a display quality is stable and which has a wide angle of view.

It should be noted that the technical scope of the present invention is not limited to the embodiments, and various modifications may be applied thereto without departing from the spirit of the present invention.

For example, the first embodiment described the example in which the liquid crystal molecules between the pair of substrates sandwiching the liquid crystal layer do not twist. Further, in the third embodiment, the liquid crystal molecules between the pair of substrates sandwiching the liquid crystal layer twist by 10°. However, when the liquid crystal molecules between the pair of substrates twist, the twist angle of the liquid crystal molecules is not necessarily limited to 10°, and may be appropriately set. Here, if the twist angle of the liquid crystal molecules is excessively increased, in the 2-domain technique, line symmetry in the viewing angle characteristics is lost. In this case, it is difficult to embody the sixth embodiment in which the light diffusion film is combined. Accordingly, it is preferable that the twist angle of the liquid crystal molecules is smaller than 45°.

Also, in the configuration of the embodiments, the two domains are provided in one sub pixel, but instead of this configuration, for example, the following configuration may be adopted: one sub pixel is divided into four parts such that the boundary lines between the domains are parallel with each other, and the first domain, the second domain, the first domain, and the second domain are repeatedly arranged. This configuration has the four domains, but is different from the conventional 4-domain technique in which the boundary lines between the domains are orthogonal to each other. In this case, it is also possible to obtain the same effect as those of the embodiments. Further, the embodiments described the examples in which the area of the first domain D1 is greater than the area of the second domain D2, but the areas of the domains need not necessarily be different, and may be the same.

Also, the number of components, arrangement, dimensions, materials, and the like of the liquid crystal display device are not limited to the disclosure of the embodiments, and may be appropriately modified.

### INDUSTRIAL APPLICABILITY

The present invention can be applied to liquid crystal display devices used in a display section and the like of various electronic apparatuses.

### REFERENCE SIGNS LIST

1, 41 LIQUID CRYSTAL DISPLAY DEVICE
2 LIGHT DIFFUSION FILM (LIGHT DIFFUSION MEMBER)
9 TFT SUBSTRATE (FIRST SUBSTRATE)
10 COLOR FILTER SUBSTRATE (SECOND SUBSTRATE)
11 LIQUID CRYSTAL LAYER
11B LIQUID CRYSTAL MOLECULES
13 LIQUID CRYSTAL PANEL
27, 34 ALIGNMENT FILM (VERTICAL ALIGNMENT FILM)
44 TRANSPARENT BASE
45 LIGHT BLOCKING PORTION
46 LIGHT DIFFUSION PORTION
D1 FIRST DOMAIN
D2 SECOND DOMAIN
J BOUNDARY LINE BETWEEN DOMAINS

1. A liquid crystal display device comprising
a liquid crystal panel that has first and second substrates which face each other, vertical alignment films which are respectively provided on the first and second substrates, and a liquid crystal layer which is sandwiched between the first and second substrates and has negative dielectric anisotropy,
wherein the liquid crystal panel has a plurality of unit regions as fundamental display units,
wherein each unit region has a first domain in which an azimuth angle component of a director of liquid crystal molecules in a middle portion of the liquid crystal layer in a thickness direction is oriented in a first direction, and a second domain in which an azimuth angle component of a director of liquid crystal molecules in the middle portion of the liquid crystal layer in the thickness direction is oriented in a second direction,
wherein the first direction and the second direction are not parallel, and the twist angle of the liquid crystal molecules in the liquid crystal layer between the first substrate and the second substrate is smaller than 45°, and
wherein an angle formed between the first direction and the second direction is equal to or greater than 6° and is equal to or less than 20°.

2. (canceled)

3. The liquid crystal display device according to claim 1, wherein an alignment regulation direction of the vertical alignment film on the first substrate is in parallel with an alignment regulation direction of the vertical alignment film on the second substrate, and the liquid crystal molecules in the liquid crystal layer do not twist between the first substrate and the second substrate.

4. The liquid crystal display device according to claim 3, wherein an alignment regulation direction of the vertical alignment film on the first substrate is not in parallel with a direction in which a boundary line between the first domain and the second domain extends, and an alignment regulation direction of the vertical alignment film on the second substrate is not in parallel with the direction in which the boundary line extends.

5. The liquid crystal display device according to claim 3, wherein either one of the alignment regulation direction of the vertical alignment film on the first substrate and the alignment regulation direction of the vertical alignment film on the second substrate is not in parallel with a direction in which a boundary line between the first domain and the second domain extends, and the other of the alignment regulation direction of the vertical alignment film on the first substrate and the alignment regulation direction of the vertical alignment film on the second substrate is in parallel with the direction in which the boundary line extends.

6. The liquid crystal display device according to claim 1, wherein an alignment regulation direction of the vertical alignment film on the first substrate is not in parallel with an alignment regulation direction of the vertical alignment film on the second substrate, and the liquid crystal molecules in the liquid crystal layer twist between the first substrate and the second substrate.

7. The liquid crystal display device according to claim 1, further comprising
a light diffusion member that has a diffusion intensity which is different in accordance with an azimuth angle direction on a light emission side of the liquid crystal panel,
wherein an azimuth angle direction, in which the diffusion intensity of the light diffusion member is relatively large, substantially coincides with an azimuth angle direction in which change in transmittance of the liquid crystal panel is relatively large.

8. The liquid crystal display device according to claim 7,
wherein the light diffusion member has a base which has optical transparency, a plurality of light blocking portions formed on a first face of the base, and a light diffusion portion formed in a region other than a region, in which the light blocking portion is formed, on the first face,
wherein the light diffusion portion has a light emission end face on a side of the base and a light incidence end face having an area larger than an area of the light emission end face on a side opposite to the side of the base, and a height from the light incidence end face of the light diffusion portion to the light emission end face is greater than a thickness of the light blocking portion, and
wherein a planar shape of the light blocking portion is an anisotropic shape having a major axis and a minor axis.
